(19) United States
(12) Patent Application Publication
(10) Pub. No.: US 2022/0002614 A1
(43) Pub. Date: Jan. 6, 2022

(54) METHOD FOR EXTRACTING PETROLEUM FROM UNDERGROUND DEPOSITS HAVING HIGH SALINITY

(71) Applicant: BASF SE, Ludwigshafen am Rhein (DE)

(72) Inventors: Christian BITTNER, Ludwigshafen am Rhein (DE); Christian SPINDLER, Ludwigshafen am Rhein (DE); Guenter OETTER, Ludwigshafen am Rhein (DE); David LEY, Ludwigshafen am Rhein (DE); Lorenz SIGGEL, Heidelberg (DE)

(21) Appl. No.: 17/295,903

(22) PCT Filed: Nov. 19, 2019
(86) PCT No.: PCT/EP2019/081782

§ 371 Date: May 21, 2021

(30) Foreign Application Priority Data
Nov. 23, 2018 (EP) 18207957.4

(51) Int. Cl. C09K 8/584; C09K 8/28

(52) U.S. Cl. CPC C09K 8/584; C09K 8/28

(57) ABSTRACT

The present invention relates to a method of producing mineral oil from an underground mineral oil deposit, in which an aqueous saline surfactant formulation comprising a surfactant mixture, for the purpose of lowering the interfacial tension between oil and water to <0.1 mN/m, is injected through at least one injection well into the mineral oil deposit and crude oil is withdrawn from the deposit through at least one production well, wherein the mineral oil deposit is at a temperature of ≥25° C. and <130° C. and has formation water with a salinity of ≥50 000 ppm of dissolved salts, and wherein the surfactant mixture comprises at least one anionic surfactant (A) of the general formula R¹—O—(CH₂CH₂O)ₒ—(CH₂)ₚ—Y⁻M⁺ (I) and at least one anionic surfactant (B) of the general formula R²—O—(CH₂CH₂O)ₒ—(CH₂)ₚ—Y⁻M⁺ (II), wherein there is a molar ratio of anionic surfactant (A) to anionic surfactant (B) in the surfactant mixture on injection of 90:10 to 10:90, and wherein the surfactant mixture does not comprise any ionic surfactant of the general formula (R^{1a})ₖ—N⁺(R^{2a})₍₃₋ₖ₎R^{3a}(X⁻)ₗ (III). The invention further relates to a concentrate of the surfactant mixture and to the use thereof.

The present invention relates to a method of producing mineral oil from an underground mineral oil deposit, in which an aqueous saline surfactant formulation comprising a surfactant mixture, for the purpose of lowering the interfacial tension between oil and water to <0.1 mN/m, is injected through at least one injection well into the mineral oil deposit and crude oil is withdrawn from the deposit through at least one production well, wherein the mineral oil deposit is at a temperature of ≥25° C. and <130° C. and has formation water with a salinity of ≥50 000 ppm of dissolved salts, and wherein the surfactant mixture comprises at least one anionic surfactant (A) and at least one anionic surfactant (B). The invention further relates to a concentrate of the surfactant mixture and to the use thereof.

Surfactants for mineral oil production (tertiary mineral oil production) should, among other properties, have good solubility in saline water at reservoir temperature and give very low interfacial tensions (of less than 0.1 mN/m) with respect to the crude oil. Ideally, the surfactant solution should form a Winsor type III microemulsion on contact with crude oil. The use of just one surfactant is usually very difficult since it either has good solubility or gives low interfacial tensions (i.e. Winsor type III microemulsions), but very often does not have both properties at the same time. This is especially true of mineral oil deposits when the formation water has high salinity (e.g. 100 000 ppm of dissolved salts (TDS=total dissolved salts) or more). Moderate temperatures (e.g. 50° C.-89° C.) and relatively high temperatures (e.g. 90 to 130° C.) in the deposit aggravate the problem.

Olefinsulfonates or alkylarylsulfonates on their own do not have sufficient tolerance to salt—especially in the case of presence of polyvalent cations such as calcium ions and magnesium ions. Alkyl alkoxylates used on their own have a cloud point below 90° C. at TDS 100 000 ppm. Anionically modified alkyl alkoxylates which have propyleneoxy groups can sometimes also have solubility problems in the case of combination of elevated temperature and high salinity. Solubility is usually not traumatic at low temperatures and low salinities.

As a result of the high temperatures, thermally stable compounds that do not break down in the course of the flooding process are required. The result of this flooding process, according to the distance from the injection well to the production well, can be that the surfactants used are subject to high temperatures over a period from half a year up to four years.

The conditions of high salinity described exist in many oil deposits composed of carbonate rock (for example in Russia, oil deposits in carbonate rock, called carbonate rock deposits, with ≥50° C. and TDS >100 000 ppm; or, for example, in the Middle East: oil deposits in carbonate rock, called carbonate rock deposits, with >90° C. and TDS >100 000 ppm). The surfactants used are said to have an acceptable, i.e. minimum, tendency to be adsorbed on the carbonate rock.

U.S. Pat. No. 4,886,120 mentions anionic surfactants of the R—(OCH₂CH₂)ₙ—OSO₃M type based on an alkyl radical R having 16 or 18 carbon atoms in tertiary mineral oil production. In the repeat units, n is a number from 2 to 5. M represents sodium. In the examples, there are only figures for a deposit with 30° C. and seawater.

EP 0177098 discloses a surfactant mixture for tertiary mineral oil production, consisting of an alkyl ether carboxylate and an alkylarylsulfonate. In the examples there are surfactants of the C12C13 4.5 EO—CH₂CO₂Na, C12C13-6 EO—CH₂CO₂Na and C₁₂-C₁₅-9 EO—CH₂CO₂Na type. It is explicitly mentioned in table 1 that the sole use of these alkyl ethoxy carboxylates does not lead to a Winsor type III microemulsion.

EP 0047370 describes the use of anionic surfactants of the R—(OCH₂CH₂)ₙ—OCH₂COOM type, which are based on an alkyl radical R having 6 to 20 carbon atoms or an alkylated aromatic radical in which the total number of carbon atoms in the alkyl radicals is 1 to 14, in tertiary mineral oil production. In the repeat units, n is a number from 3 to 30. M represents an alkali metal atom. The examples show only the use of carboxymethylated nonylphenol ethoxylate sodium salt with, for example, n=6 (carboxymethylation level 80%) or carboxymethylated fatty alcohol ethoxylate sodium salt with, for example, R=C12C14 and n=4.5 (carboxymethylation level 65%) or carboxymethylated fatty alcohol ethoxylate sodium salt with, for example, R=C16 and n=4.5 (carboxymethylation level 65%).

EP 0047369 describes the use of anionic surfactants of the R—(OCH₂CH₂)ₙ—OCH₂COOM type, which are based on an alkyl or alkylaryl radical R having 4 to 20 carbon atoms or an alkylated aromatic radical in which the total number of carbon atoms in the alkyl radicals is 1 to 14, in tertiary mineral oil production. In the repeat units, n is a number from 3 to 15. M represents an alkali metal atom or alkaline earth metal atom. In the examples, there are only figures for compounds in which the alkylaryl radical is a nonylphenyl radical.

U.S. Pat. No. 4,457,373 A describes the use of water-oil emulsions of anionic surfactants of the R—(OCH₂CH₂)ₙ—OCH₂COOM type, which are based on an alkyl radical R having 6 to 20 carbon atoms or an alkylated aromatic radical in which the total number of carbon atoms in the alkyl radicals is 3 to 28, in tertiary mineral oil production. In the repeat units, n is a number from 1 to 30. The surfactants are prepared via a reaction of the corresponding alkoxylates with chloroacetic acid sodium salt and sodium hydroxide or aqueous sodium hydroxide solution. The carboxymethylation level may range from 10% to 100% (preferably 90-100%). The examples show only the use of water-oil emulsions with carboxymethylated nonylphenol ethoxylate sodium salt with, for example, n=6 (carboxymethylation level 80%) or carboxymethylated fatty alcohol ethoxylate sodium salts with, for example, R=C12C14 and n=4.5 (carboxymethylation level 94%) or carboxymethylated fatty alcohol ethoxylate sodium salts with, for example, R=C16 and n=4.5 (carboxymethylation level 65%) or carboxymethylated fatty alcohol ethoxylate sodium salts with, for example, R=C16 and n=7 (carboxymethylation level 90%) against crude oil in saltwater at temperatures of 46 to 85° C. The surfactant concentration used (>5 percent by weight) was very high in the flooding tests, which were conducted at ≤55° C. A polymer (polysaccharides) was used in the flooding tests.

U.S. Pat. No. 4,485,873 A describes the use of anionic surfactants of the R—(OCH₂CH₂)ₙ—OCH₂COOM type, which are based on an alkyl radical R having 4 to 20 carbon atoms or an alkylated aromatic radical in which the total number of carbon atoms in the alkyl radicals is 1 to 28, in tertiary mineral oil production. In the repeat units, n is a number from 1 to 30. The surfactants are prepared via a reaction of the corresponding alkoxylates with chloroacetic acid sodium salt and sodium hydroxide or aqueous sodium hydroxide solution. The carboxymethylation level may range from 10% to 100% (preferably 50-100%). The examples show only the use of carboxymethylated nonylphenol ethoxylate sodium salts with, for example, n=5.5 (carboxymethylation level 70%) or carboxymethylated fatty alcohol ethoxylate sodium salt with, for example, R=C12C14 and n=4.4 (carboxymethylation level 65%) or carboxymethylated fatty alcohol ethoxylate sodium salt with, for example, R=C16 and n=4.5 (carboxymethylation level 65%) against model oil in saltwater at temperatures of 37 to 74° C. The surfactant concentration used (>5 percent by weight) was very high in the flooding tests, which were conducted at ≤60° C. The polymer used in the flooding tests was hydroxyethyl cellulose.

U.S. Pat. No. 4,542,790 A describes the use of anionic surfactants of the R—(OCH₂CH₂)ₙ—OCH₂COOM type, which are based on an alkyl radical R having 4 to 20 carbon atoms or an alkylated aromatic radical in which the total number of carbon atoms in the alkyl radicals is 1 to 28, in tertiary mineral oil production. In the repeat units, n is a number from 1 to 30. The surfactants are prepared via a reaction of the corresponding alkoxylates with chloroacetic acid sodium salt and sodium hydroxide or aqueous sodium hydroxide solution. The carboxymethylation level may range from 10% to 100%. The examples show the use of carboxymethylated nonylphenol ethoxylate sodium salts with, for example, n=5.3 (carboxymethylation level 76%) or carboxymethylated C12C14 fatty alcohol ethoxylate sodium salts against low-viscosity crude oil (10 mPas at 20° C.) in salt water at temperatures of 46 to 85° C. The surfactant concentration used (2 percent by weight) was relatively high in the flooding tests, which were conducted at ≤60° C.

U.S. Pat. No. 4,811,788 A1 discloses the use of R—(OCH₂CH₂)ₙ—OCH₂COOM which are based on the alkyl radical 2-hexyldecyl (derived from C16 Guerbet alcohol) and in which n is the number 0 or 1 in tertiary mineral oil production.

EP 0207312 B1 describes the use of anionic surfactants of the R—(OCH₂C(CH₃)H)ₘ(OCH₂CH₂)ₙ—OCH₂COOM type, which are based on an alkyl radical R having 6 to 20 carbon atoms or an alkylated aromatic radical in which the total number of carbon atoms in the alkyl radicals is 5 to 40, in a blend with a more hydrophobic surfactant in tertiary mineral oil production. In the repeat units, m is a number from 1 to 20 and n is a number from 3 to 100. The surfactants are prepared via a reaction of the corresponding alkoxylates with chloroacetic acid sodium salt and sodium hydroxide or aqueous sodium hydroxide solution. The carboxymethylation level may range from 10% to 100%. The examples show the use of carboxymethylated dinonylphenol block propoxy oxethylate sodium salt with m=3 and n=12 (carboxymethylation level 75%) together with alkylbenzenesulfonate or alkanesulfonate against model oil in seawater at temperatures of 20° C. or 90° C. Oil recovery at 90° C. in core flooding tests gave poorer values than at 20° C., and the surfactant concentration used (4 percent by weight) was very high.

WO 2009/100298 A1 describes the use of anionic surfactants of the R¹—O—(CH₂C(CH₃)HO)ₘ(CH₂CH₂O)ₙ—XY⁻M⁺ type, which are based on a branched alkyl radical R¹ having 10 to 24 carbon atoms and a branching level of 0.7 to 2.5, in tertiary mineral oil production. Y— may be a carboxylate group inter alia. In the examples of the alkyl ether carboxylates, R1 is always a branched alkyl radical having 16 to 17 carbon atoms and X is always a CH₂ group. For the repeat units, examples with m=0 and n=9 and m=7 and n=2 and m=3.3 and n=6 are detailed. The surfactants are prepared via a reaction of the corresponding alkoxylates with chloroacetic acid sodium salt and aqueous sodium hydroxide solution. The carboxymethylation level is disclosed as 93% for the example with m=7 and n=2. In the examples, the alkyl ether carboxylates are tested as sole surfactants (0.2 percent by weight) in seawater at 72° C. against crude oil. The interfacial tensions attained were always above 0.1 mN/m.

WO 09124922 A1 describes the use of anionic surfactants of the R¹—O—(CH₂C(R²)HO)_{n″}(CH₂CH₂O)_{m″}—R⁵—COOM type, which are based on a branched saturated alkyl radical R¹ having 17 carbon atoms and a branching level of 2.8 to 3.7, in tertiary mineral oil production. R² is a hydrocarbyl radical having 1 to 10 carbon atoms. R₅ is a divalent hydrocarbyl radical having 1 to 12 carbon atoms. In addition, n″ is a number from 0 to 15 and m″ is a number from 1 to 20. These anionic surfactants can be obtained inter alia by oxidation of corresponding alkoxylates, with conversion of a terminal —CH₂CH₂OH group to a terminal —CH₂CO₂M group.

WO 11110502 A1 describes the use of anionic surfactants of the R¹—O—(CH₂C(CH₃)HO)ₘ(CH₂CH₂O)ₙ—XY⁻M⁺ type, which are based on a linear saturated or unsaturated alkyl radical R¹ having 16 to 18 carbon atoms, in tertiary mineral oil production. Y— may be a carboxylate group or a sulfate group inter alia, and X may be an alkyl or alkylene group having up to 10 carbon atoms inter alia. In addition, m is preferably a number from 3 to 20, and n is a number from 0 to 99. These anionic surfactants can be obtained inter alia by reaction of appropriate alkoxylates with chloroacetic acid sodium salt.

WO 2012/027757 A1 claims surfactants of the R¹—O—(CH₂C(R²)HO)ₙ(CH(R³)_{z}—COOM type and the use thereof in tertiary mineral oil production. R¹ represents alkyl radicals or optionally substituted cycloalkyl or optionally substituted aryl radicals each having 8 to 150 carbon atoms. R² or R³ may be H or alkyl radicals having 1 to 6 carbon atoms. The value n is a number from 2 to 210 and z is a number from 1-6. The only examples are surfactant mixtures at least comprising a sulfonate-containing surfactant (e.g. internal olefinsulfonates or alkylbenzenesulfonates) and an alkyl ether carboxylate in which R1 is a branched saturated alkyl radical having 24 to 32 carbon atoms and derives from Guerbet alcohols having only one branch (in the 2 position). Said alkyl ether carboxylates have at least 25 repeat units in which R² is CH₃, and at least 10 repeat units in which R² is H, and so n is at least a number greater than 39. In all the examples, R³ is H and z is the number 1.

The surfactant mixtures comprise at least 0.5 percent by weight of surfactant and are tested at temperatures of 30 to 105° C. against crude oils.

WO 2013/159027 A1 claims surfactants of the R¹—O—(CH₂C(R²)HO)ₙ—X type and the use thereof in tertiary mineral oil production. R¹ represents alkyl radicals each having 8 to 20 carbon atoms, or optionally substituted cycloalkyl or optionally substituted aryl radicals. R² may be H or CH₃. The value n is a number from 25 to 115. X is SO₃M, SO₃H, CH₂CO₂M or CH₂CO₂H (M⁺ is a cation). Additionally disclosed are structures of the R₁—O—(CH₂C(CH₃)HO)ₓ—(CH₂CH₂O)_{y}—X type, where x is a number from 35 to 50 and y is a number from 5 to 35. One example is the surfactant C₁₈H₃₅—O—(CH₂C(CH₃)HO)₄₅—(CH₂CH₂O)₃₀—CH₂CO₂M (C₁₈H₃₅ is oleyl) in a blend with an internal C₁₉-C₂₈ olefinsulfonate and phenyl diethylene glycol. The surfactant mixtures comprise at least 1.0 percent by weight of surfactant and are tested at temperatures of 100° C. and total salinity 32500 ppm in the presence of the base sodium metaborate against crude oils.

WO 2016/079121 A1 claims a surfactant mixture of R¹—O—(CH₂C(R²)HO)ₓ—(CH₂C(CH₃)HO)_{y}—(CH₂CH₂O)_{z}—CH₂CO₂M and R¹—O—(CH₂C(R²)HO)ₓ—(CH₂C(CH₃)HO)_{y}—(CH₂CH₂O)_{z}—H in a molar ratio of 51:49 to 92:8, and the use thereof in tertiary mineral oil production in deposits having temperatures of 55° C. to 150° C. R¹ represents alkyl radicals each having 10 to 36 carbon atoms. In the examples, there are deposit conditions with TDS 148 200 ppm and 100° C.

In spite of the surfactants and surfactant mixtures known in the prior art, there is a need for improved surfactant mixtures, especially for use in methods of mineral oil production in deposits having high salinity and temperatures below 90° C. In this context, both the solubility and the properties of lowering interfacial tension are to be improved.

It is therefore an object of the present invention to provide such a method and a concentrate.

The object is achieved by a method of producing mineral oil from an underground mineral oil deposit, in which an aqueous saline surfactant formulation comprising a surfactant mixture, for the purpose of lowering the interfacial tension between oil and water to <0.1 mN/m, is injected through at least one injection well into the mineral oil deposit and crude oil is withdrawn from the deposit through at least one production well, wherein

the mineral oil deposit is at a temperature of ≥25° C. and <130° C. and has formation water with a salinity of ≥50 000 ppm of dissolved salts,

and wherein the surfactant mixture comprises at least one anionic surfactant (A) of the general formula (I)

R¹—O—(CH₂CH₂O)ₒ—(CH₂)ₚ—Y⁻M⁺ (I)

and at least one anionic surfactant (B) of the general formula (II)

R²—O—(CH₂CH₂O)ₒ—(CH₂)ₚ—Y⁻M⁺ (II)

wherein there is a molar ratio of anionic surfactant (A) to anionic surfactant (B) in the surfactant mixture on injection of 90:10 to 10:90,

where

R¹ is a linear saturated or unsaturated aliphatic hydrocarbyl radical having 16 carbon atoms;

R² is a linear saturated or unsaturated aliphatic hydrocarbyl radical having two methylene groups more than R¹;

each Y is independently SO₃ or CO₂;

each M is independently Na, K, N(CH₂CH₂OH)₃H, N(CH₂CH(CH₃)OH)₃H, N(CH₃)(CH₂CH₂OH)₂H, N(CH₃)₂(CH₂CH₂OH)H, N(CH₃)₃(CH₂CH₂OH), N(CH₃)₃H, N(C₂H5)₃H or NH₄;

each o is independently a number from 6 to 20;

each p is independently a number from 0 to 3;

where

p is the number 1 if Y is CO₂;

p is the number 0, 2 or 3 if Y is SO₃;

where the surfactant mixture does not comprise any ionic surfactant of the general formula (III)

(R^{1a})ₖ—N₊(R^{2a})₍₃₋ₖ₎R^{3a}(X⁻)ₗ (III)

where

each R^{1a} is independently a linear or branched, saturated or unsaturated, aliphatic hydrocarbyl radical having 8 to 22 carbon atoms, or is the R^{4a}—O—(CH₂C(R^{5a})HO)ₘₐ—(CH₂C(CH₃)HO)ₙₐ—(CH₂CH₂O)ₒₐ—(CH₂CH₂)— or R^{4a}—O—(CH₂C(R^{5a})HO)ₘₐ—(CH₂C(CH₃)HO)ₙₐ—(CH₂CH₂O)ₒₐ—(CH₂C(CH₃)H)— radical;

each R^{2a} is CH₃;

R^{3a} is CH₃ or (CH₂CO₂)—;

each R^{4a} is independently a linear or branched, saturated or unsaturated, aliphatic hydrocarbyl radical having 8 to 36 carbon atoms or an aromatic or aromatic-aliphatic hydrocarbyl radical having 8 to 36 carbon atoms;

each R^{5a} is independently a linear or branched, saturated or unsaturated, aliphatic hydrocarbyl radical having 2 to 16 carbon atoms or an aromatic or aromatic-aliphatic hydrocarbyl radical having 6 to 10 carbon atoms;

X is Cl, Br, I or H₃CO—SO₃;

k is the number 1 or 2,

l is the number 0 or 1;

each ma is independently a number from 0 to 15;

each na is independently a number from 0 to 50;

each oa is independently a number from 1 to 60;

where

the sum total of na+oa is a number from 7 to 80;

l is the number 0 if R³ is (CH₂CO₂)⁻or is 1 if R³ is CH₃.

A surfactant mixture as described above surprisingly shows very good thermal stability and can therefore be used in the method of the invention. Moreover, advantages are likewise shown by a corresponding concentrate.

Accordingly, the present invention further provides a concentrate comprising, based in each case on the total amount of the concentrate,

20% by weight to 90% by weight of a surfactant mixture of the invention, where the molar ratio of anionic surfactant (A) to anionic surfactant (B) may be as desired, 5% by weight to 40% by weight of water and 5% by weight to 40% by weight of a cosolvent.

It is surprisingly possible to achieve particularly good properties even under very difficult conditions when a surfactant mixture comprising surfactants (A) and (B) as described herein is used. It is possible here to achieve sufficient solubility of the surfactants in the deposit water, and simultaneously to achieve the formation of a Winsor type III microemulsion in the presence of crude oil. It is additionally surprising that the positive properties of the surfactant mixture can be further improved when surfactants (C) are additionally present in the surfactant mixture.

Surfactant mixtures comprising anionic surfactant (A) of the general formula (I) and anionic surfactant (B) of the general formula (II) are suitable for deposits composed of carbonate rock (preferably weakly negatively charged or uncharged carbonate rock having a zeta potential of −4 to 0 mV and more preferably positively charged carbonate rock having a zeta potential >0 mV).

In the method of the invention, the surfactant mixture includes at least one surfactant (A) of the general formula (I) and at least one surfactant (B) of the general formula (II), and preferably at least one anionic surfactant (C) of the general formula (IV). On injection, i.e. at the time at which the surfactant mixture forms the aqueous saline surfactant formulation together with injection water, and this is injected into the ground (“injection”), the molar ratio of surfactant (A) to surfactant (B) is 90:10 to 10:90. Accordingly, the surfactant formulation comprises at least the surfactant mixture and water and optionally further salts, especially those that are present in saline water, such as seawater, and optionally at least one anionic surfactant (C).

Accordingly, the aqueous saline surfactant formulation is understood to mean a surfactant mixture, optionally with at least one anionic surfactant (C), which is dissolved in saline water (for example during the injection operation). The saline water may, inter alia, be river water, seawater, water from an aquifer close to the deposit, so-called injection water, deposit water, so-called production water which is being reinjected again, or mixtures of the above-described waters.

However, the saline water may also be that which has been obtained from a more saline water: for example partial desalination, depletion of the polyvalent cations or by dilution with fresh water or drinking water. The surfactant mixture can preferably be provided as a concentrate which, as a result of the preparation, may also comprise salt. This is detailed further in the paragraphs which follow.

There is preferably a molar ratio of ionic surfactant (A) to anionic surfactant (B) on injection of the surfactant mixture of 80:20 to 20:80, preferably 40:60 to 20:80, more preferably 30:70.

The surfactant mixture includes at least one anionic surfactant (A) of the general formula (I)

R¹—O—(CH₂CH₂O)ₒ—(CH₂)ₚ—Y⁻M⁺ (I)

and at least one anionic surfactant (B) of the general formula (II)

R²—O—(CH₂CH₂O)ₒ—(CH₂)ₚ—Y⁻M⁺ (II).

Accordingly, there may be one anionic surfactant (A) or multiple anionic surfactants (A), such as two, three or more ionic surfactants (A). The same applies to the anionic surfactant (B).

The R¹ radical is a linear saturated or unsaturated aliphatic hydrocarbyl radical having 16 carbon atoms. It is preferable that the radical that R¹ is a linear saturated aliphatic primary hydrocarbyl radical having 16 carbon atoms.

The R² radical is a linear saturated or unsaturated aliphatic hydrocarbyl radical having two methylene groups more than R¹. It is preferable that the R² radical is a linear saturated aliphatic primary hydrocarbyl radical having 18 carbon atoms.

The variable o indicates how many ethylene oxide units are present in the surfactants of the formulae (I) and (II). There are 6 to 20 ethylene oxide units. For formula (I), these may be the same or different by comparison with formula (II); they are preferably the same. Preferably, o is a number from 6 to 15, preferably a number from 8 to 12, especially 10.

The variable p indicates whether there are no (p=0), one (p=1), two (p=2) or three (p=3) methylene groups in formulae (I) and (II). In the two formulae, these may independently be present (p=1, 2 or 3) or not (p=0). This is preferably equally present or not for both formulae; further preferably, this is present for both formulae (p=1, 2 or 3); more preferably, p=1. It is accordingly preferable that at least for one anionic surfactant (A) or (B) is a carboxylate. More preferably, each anionic surfactant (A) and (B) is a carboxylate.

The Y radical indicates the anion Y⁻. It may be a sulfate (Y=SO₃, p=0), a sulfonate (Y=SO₃, p=2 or 3) or a carboxylate (Y=CO₂, p=1). Preference is given to carboxylate.

The variable M denotes the cation in the formulae (I) and (II). The cation of the formula (I) may be the same or different by comparison with the cation of the formula (II), but is preferably the same. The cation is Na, K, N(CH₂CH₂OH)₃H, N(CH₂CH(CH₃)OH)₃H, N(CH₃)(CH₂CH₂OH)₂H, N(CH₃)₂(CH₂CH₂OH)H, N(CH₃)₃(CH₂CH₂OH), N(CH₃)₃H, N(C₂H5)₃H or NH₄. The cation is preferably selected from Na, K or NH₄. Na is further preferred.

The anionic surfactants (A) and (B) in the surfactant mixture in the method of the invention are in undissolved, partly dissolved or fully dissolved form in the aqueous saline surfactant formulation, preferably in fully dissolved form.

Ionic surfactants (A) and (B) are either commercially available or can be prepared via known methods known to the competent person of average skill in the art. By way of example, reference is made here to WO 2016/079121 A1. The same applies to the surfactants (C) that are preferably likewise present.

The surfactant mixture in the method of the invention preferably does not comprise any ionic surfactant of the general formula (III)

(R^{1a})ₖ—N⁺(R^{2a})₍₃₋ₖ₎R^{3a}(X⁻)ₗ (III)

where

each R^{1a} is independently a linear or branched, saturated or unsaturated, aliphatic hydrocarbyl radical having 8 to 22 carbon atoms, or is the R^{4a}—O—(CH₂C(R^{5a})HO)ₘₐ—(CH₂C(CH₃)HO)ₙₐ—(CH₂CH₂O)ₒₐ—(CH₂CH₂)— or R^{4a}—O—(CH₂C(R^{5a})HO)ₘₐ—(CH₂C(CH₃)HO)ₙₐ—(CH₂CH₂O)ₒₐ—(CH₂C(CH₃)H)— radical;

each R^{2a} is CH₃;

R^{3a} is CH₃ or (CH₂CO₂)—;

each R^{4a} is independently a linear or branched, saturated or unsaturated, aliphatic hydrocarbyl radical having 8 to 36 carbon atoms or an aromatic or aromatic-aliphatic hydrocarbyl radical having 8 to 36 carbon atoms;

each R^{5a} is independently a linear or branched, saturated or unsaturated, aliphatic hydrocarbyl radical having 2 to 16 carbon atoms or an aromatic or aromatic-aliphatic hydrocarbyl radical having 6 to 10 carbon atoms;

X is Cl, Br, I or H₃CO—SO₃;

k is the number 1 or 2,

l is the number 0 or 1;

each ma is independently a number from 0 to 15;

each na is independently a number from 0 to 50;

each oa is independently a number from 1 to 60;

where

the sum total of na+oa is a number from 7 to 80;

l is the number 0 if R³ is (CH₂CO₂)⁻ or is 1 if R³ is CH₃.

Surfactant mixtures of individual anionic surfactants (A) and (B) with the ionic surfactant of the formula (III) are known from WO 2018/219654 A1. Accordingly, there are preferably no ionic surfactants of the formula (III) as described in WO 2018/219654 A1. However, surfactant mixtures of anionic surfactants (A), (B) and (C) are not known from WO 2018/219654 A1, and so, for this combination in the surfactant mixture according to the present invention, surfactants of the formula (III) may also be present.

Preferably, the surfactant mixture according to the present invention, as well as at least one surfactant of the formula (I) and at least one surfactant of the formula (II), additionally comprises at least one anionic surfactant (C) of the general formula (IV)

R^{3b}—O—(CH₂CHCH₃O)_{nb}—(CH₂CH₂O)_{ob}—(CH₂)_{pb}—Y_{b}⁻M_{b}⁺ (IV)
where
R^{3b} is a linear or branched, saturated or unsaturated, aliphatic primary hydrocarbyl radical having 16 to 18 carbon atoms;
Y_{b} is SO₃ or CO₂;
M_{b} is Na, K, N(CH₂CH₂OH)₃H, N(CH₂CH(CH₃)OH)₃H, N(CH₃)(CH₂CH₂OH)₂H, N(CH₃)₂(CH₂CH₂OH)H, N(CH₃)₃(CH₂CH₂OH), N(CH₃)₃H, N(C₂H5)₃H or NH₄;
nb is a number from 3 to 10;
ob is independently a number from 8 to 20;
pb is independently a number from 0 to 3;
where
pb is the number 1 if Y_{b} is CO₂;
pb is the number 0, 2 or 3 if Y_{b} is SO₃.

Accordingly, there may be one anionic surfactant (C) or multiple anionic surfactants (C), such as two, three or more anionic surfactants (C).

The R^{3b} radical here is a linear or branched, saturated or unsaturated, aliphatic primary hydrocarbyl radical having 16 to 18 carbon atoms. The R^{3b} radical is preferably a linear saturated or unsaturated aliphatic primary hydrocarbyl radical having 16 to 18 carbon atoms. The R^{3b} radical is further preferably a linear saturated aliphatic primary hydrocarbyl radical having 16 to 18 carbon atoms. There are preferably at least two R^{3b} radicals for two surfactants which have 16 and 18 carbon atoms and correspond to surfactants (A) and (B) except for the ethyleneoxy and propyleneoxy units present. This is also true of the molar ratio to one another. This can especially be achieved in that the same alcohol mixture is used for production of the surfactants of the formulae (I) and (II), and (IV).

The variable pb indicates whether there are no (pb=0), one (pb=1), two (pb=2) or three (pb=3) methylene groups in formula (IV). These may be present (pb=1, 2 or 3) or not (pb=0). These are preferably present (pb=1, 2 or 3); more preferably, pb=1.

The Y_{b} radical indicates the anion Y_{b}⁻. It may be a sulfate (Y_{b}=SO₃, pb=0), a sulfonate (Y_{b}=SO₃, pb=2 or 3) or a carboxylate (Y_{b}=CO₂, pb=1). Preference is given to carboxylate. Accordingly, Y_{b} and pb are preferably CO₂ and 1.

The variable ob indicates how many ethylene oxide units are present in the surfactant of the formula (IV). There are 8 to 20 ethylene oxide units. Preferably, ob is a number from 8 to 18, further preferably a number from 8 to 15, further preferably a number from 8 to 12, further preferably a number from 9 to 11, especially 10.

The variable Mb denotes the cation in formula (IV). The cation is Na, K, N(CH₂CH₂OH)₃H, N(CH₂CH(CH₃)OH)₃H, N(CH₃)(CH₂CH₂OH)₂H, N(CH₃)₂(CH₂CH₂OH)H, N(CH₃)₃(CH₂CH₂OH), N(CH₃)₃H, N(C₂H5)₃H or NH₄. The cation is preferably selected from Na, K or NH₄. Na is further preferred. It is especially preferable that “Mb” assumes the same value as the variable M in formula (I) or formula (II), especially in formulae (I) and (II).

The number nb indicates the number of propyleneoxy units in formula (IV). This is in the range from 3 to 10. Accordingly, there are 3, 4, 5, 6, 7, 8, 9 or 10 propyleneoxy units in formula (IV). There are preferably 4, 5, 6, 7, 8 or 10 propyleneoxy units in formula (IV). There are more preferably 5, 6, 7, 8 or 9 propyleneoxy units in formula (IV). There are even more preferably 6, 7 or 8, especially 7, propyleneoxy units in formula (IV).

In the case of presence of surfactant mixtures comprising multiple surfactants (A)/(B) and optionally (C) of the general formula (I)/(II) or (IV), the numbers o, nb, ob may, as already set out above, be averages over all molecules of the surfactants. Especially in the case of alkoxylation of alcohol with ethylene oxide or propylene oxide, a certain distribution of chain lengths is typically obtained in each case. This distribution can be described in a manner known in principle by what is called the polydispersity D. D=M_{w}/Mₙ is the ratio of the weight-average molar mass and the number-average molar mass. The polydispersity can be determined by methods known to those skilled in the art, for example by means of gel permeation chromatography. If a single formula is specified for a surfactant, in the absence of further information, this is the most common compound in the mixture.

The alkyleneoxy groups may thus be arranged in random distribution, alternately or in blocks, i.e. in two, three, four or more blocks.

Preferably, the nb propyleneoxy and ob ethyleneoxy groups in formula (IV) are at least partially arranged in blocks (in numerical terms, preferably to an extent of at least 50%, more preferably to an extent of at least 60%, even more preferably to an extent of at least 70%, more preferably to an extent of at least 80%, more preferably to an extent of at least 90%, especially completely).

In the context of the present invention, “arranged in blocks” means that at least one alkyleneoxy has a neighboring alkyleneoxy group which is chemically identical, such that these at least two alkyleneoxy units form a block. Particularly preferably, the R^{3b}—O radical is followed by a propyleneoxy block having nb propyleneoxy groups and then an ethyleneoxy block having ob ethyleneoxy groups.

Preferably, the molar ratio of the sum total of surfactant (A) and surfactant (B) relative to surfactant (C), ((A)+(B):(C)), is in the range from 100:0 to 50:50, more preferably from 90:10 to 50:50.

The method of the invention serves to produce mineral oil from underground mineral oil deposits, in which an aqueous saline surfactant formulation comprising a surfactant mixture is used for the purpose of lowering the interfacial tension between oil and water to <0.1 mN/m. The formulation is injected here into a mineral oil deposit through at least one injection well, and crude oil is withdrawn from the deposit through at least one production well, wherein the mineral oil deposit has a temperature of ≥25° C. and <130° C. and has formation water having a salinity of ≥50 000 ppm (proportion by weight based on total weight) of dissolved salts (TDS). The mineral oil deposit preferably has formation water having a salinity of ≥75 000 ppm of dissolved salts, preferably ≥100 000 ppm, more preferably ≥120 000 ppm, even more preferably ≥130 000 ppm, of dissolved salts. The mineral oil deposit preferably has a temperature of ≥50° C., preferably ≥65° C., and preferably <90° C.

For the determination of the mineral oil deposit temperature, for example, well measurements are conducted, in which a thermometer suspended from a cable is dropped into the wells and the temperature of the oil-bearing zone is measured at two or more depths. This ascertains the average temperature that constitutes the mineral oil deposit temperature. Measurements of mineral oil deposit temperature frequently proceed using optical fibers (see also http://petrowiki.org/Reservoir_pressure_and_temperature#Measurement_of_reservoir_pressure_and_temperature).

Salinity can be determined via inductively coupled plasma mass spectrometry (ICP-MS).

In a further preferred execution of the invention, a thickening polymer from the group of the biopolymers or from the group of the copolymers based on acrylamide is added to the aqueous saline surfactant formulation. The copolymer may consist, for example, of the following units inter alia:
acrylamide and acrylic acid sodium salt
acrylamide and acrylic acid sodium salt and N-vinylpyrrolidone
acrylamide and acrylic acid sodium salt and AMPS (2-acrylamido-2-methylpropanesulfonic acid sodium salt)
acrylamide and acrylic acid sodium salt and AMPS (2-acrylamido-2-methylpropanesulfonic acid sodium salt) and N-vinylpyrrolidone.

Particular preference is given to the copolymer formed from acrylamide and acrylic acid sodium salt and AMPS (2-acrylamido-2-methylpropanesulfonic acid sodium salt) and N-vinylpyrrolidone. The copolymer may also comprise additional groups.

A particularly preferred execution in the method of the invention is a Winsor type III microemulsion/polymer flooding operation.

The polymers can be stabilized by addition of further additives such as biocides, stabilizers, free radical scavengers and inhibitors.

Instead of or in addition to the addition of a polymer, it is also possible to add a foam for the purpose of mobility control. The foam can be produced at the deposit surface or in situ in the deposit by injection of gases such as nitrogen or gaseous hydrocarbons such as methane, ethane or propane. The gaseous hydrocarbons may also be mixtures comprising methane, ethane or propane. The foam can be produced and stabilized by adding the surfactant mixture described herein or else further surfactants.

Optionally, it is also possible to add a base such as alkali metal hydroxide or alkali metal carbonate to the surfactant formulation, in which case it is combined with complexing agents or polyacrylates in order to prevent precipitation as a result of the presence of polyvalent cations. In addition, it is also possible to add a cosolvent to the formulation.

This gives rise to the following (combined) methods:
surfactant flooding
Winsor type III microemulsion flooding
surfactant/polymer flooding
Winsor type III microemulsion/polymer flooding
alkali/surfactant/polymer flooding
alkali/Winsor type III microemulsion/polymer flooding
surfactant/foam flooding
Winsor type III microemulsion/foam flooding
alkali/surfactant/foam flooding
alkali/Winsor type III microemulsion/foam flooding

In a preferred embodiment of the invention, one of the first four methods is employed (surfactant flooding, Winsor type III microemulsion flooding, surfactant/polymer flooding or Winsor type III microemulsion/polymer flooding). Particular preference is given to Winsor type III microemulsion/polymer flooding.

In Winsor type III microemulsion/polymer flooding, in the first step, a surfactant formulation is injected with or without polymer. The surfactant formulation, on contact with crude oil, results in the formation of a Winsor type III microemulsion. In the second step, only polymer is injected. In the first step in each case, it is possible to use aqueous formulations having higher salinity than in the second step. Alternatively, both steps can also be conducted with water of equal salinity. In the first step, it is also possible to perform a gradient operation in the surfactant mixture. This is to be elucidated by an example. Under deposit conditions, for example, a surfactant mixture comprising 30 mol % of anionic surfactant (A) of the general formula (I) to 70 mol % of anionic surfactant (B) of the general formula (II) forms a Winsor type III microemulsion with the crude oil. The injection water corresponds to the formation water in terms of its salinity. In addition, for example, surfactant (C) of the general formula (IV) is to be present to an extent of 50%. Injection commences firstly with a surfactant mixture of a constant 30 mol % of anionic surfactant (A) of the general formula (I) to 70 mol % of anionic surfactant (B) of the general formula (II) and a varying content of surfactant (C) beginning at 0%. In the course of injection, the relative ratio of (A)+(B):(C) is varied such that the ratio of 30 mol % of ionic surfactant (A) of the general formula (I) to 70 mol % of anionic surfactant (B) of the general formula (II) remains and (A)+(B):(C) of 90:10 is attained. Injection is continued thereafter, with ultimate attainment of the surfactant ratio of (A)+(B):(C) of 50:50 by further stepwise variation of the surfactant ratio. This method can optionally be conducted in the presence of other surfactants, polymer and/or foam, and other additives described above.

In one embodiment, the methods can of course also be combined with water flooding. In the case of water flooding, water is injected into a mineral oil deposit through at least one injection well, and crude oil is withdrawn from the deposit through at least one production well. The water may be freshwater or saline waters such as seawater or deposit water. After the water flooding, the method of the invention may be employed.

To execute the method of the invention, at least one production well and at least one injection well are sunk into the mineral oil deposit. In general, a deposit is provided with several injection wells and with several production wells. There may be vertical and/or horizontal wells. An aqueous formulation of the water-soluble components described is injected through the at least one injection well into the mineral oil deposit, and mineral oil is withdrawn from the deposit through at least one production well. As a result of the pressure generated by the aqueous formulation injected, called the “flood”, the mineral oil flows in the direction of the production well and is produced via the production well. The term “mineral oil” in this context of course does not just mean single-phase oil; instead, the term also encompasses the usual crude oil-water emulsions. It will be clear to the person skilled in the art that a mineral oil deposit may also have a certain temperature distribution. Said deposit temperature is based on the region of the deposit between the injection and production wells which is covered by the flooding with aqueous solutions. Methods of determining the temperature distribution of a mineral oil deposit are known in principle to those skilled in the art. The temperature distribution is generally determined from temperature measurements at particular sites in the formation in combination with simulation calculations; the simulation calculations also take account of the amounts of heat introduced into the formation and the amounts of heat removed from the formation.

The method of the invention can especially be employed in mineral oil deposits having an average porosity of 1 mD to 4 D, preferably 2 mD to 2 D and more preferably 5 mD to 500 mD. The permeability of a mineral oil formation is reported by the person skilled in the art in the unit “darcy” (abbreviated to “D” or “mD” for “millidarcies”), and can be determined from the flow rate of a liquid phase in the mineral oil formation as a function of the pressure differential applied. The flow rate can be determined in core flooding tests with drill cores taken from the formation. Details of this can be found, for example, in K. Weggen, G. Pusch, H. Rischmüller in “Oil and Gas”, pages 37 ff., Ullmann's Encyclopedia of Industrial Chemistry, Online Edition, Wiley-VCH, Weinheim 2010. It will be clear to the person skilled in the art that the permeability in a mineral oil deposit need not be homogeneous, but generally has a certain distribution, and the permeability reported for a mineral oil deposit is accordingly an average permeability.

The method is executed using an aqueous formulation comprising, as well as water, at least the described surfactant mixture of anionic surfactant (A) of the general formula (I) and the anionic surfactant (B) of the general formula (II), and optionally surfactant (C).

The formulation is made up in water comprising salts. Of course, they may be mixtures of different salts. For example, it is possible to use seawater to make up the aqueous formulation, or it is possible to use produced formation water, which is reused in this way. The water may be injection water, or else formation water from other remote reservoirs or from aquifers. In the case of offshore production platforms, the formulation is generally made up in seawater. In the case of onshore production facilities, the surfactant or polymer can advantageously first be dissolved in fresh water or low-salinity water, and the solution obtained can be diluted to the desired use concentration with formation water. The injection water may also be water from a desalination plant. Alternatively, it would be possible, for example, to reduce the sulfate ion content in seawater, such that it is possible to inject modified seawater into a deposit rich in calcium ions without precipitation.

In a preferred execution, the deposit water or seawater should include at least 100 ppm of divalent cations.

The salts may especially be alkali metal salts and alkaline earth metal salts. Examples of typical cations include Na⁺, K⁺, Mg²⁺ and/or Ca²⁺, and examples of typical anions include chloride, bromide, hydrogencarbonate, sulfate or borate.

In general, at least one or more than one alkali metal ions are present, especially at least Na⁺. In addition, alkaline earth metal ions are also be present, in which case the weight ratio of alkali metal ions/alkaline earth metal ions is generally ≥2, preferably ≥3. Anions present are generally at least one or more than one halide ion(s), especially at least Cl⁻. In general, the amount of Cl⁻ is at least 50% by weight, preferably at least 80% by weight, based on the sum total of all the anions.

Additives can be used, for example, in order to prevent unwanted side effects, for example the unwanted precipitation of salts, or in order to stabilize the surfactant or polymer used. The polymer-containing formulations injected into the formation in the flooding process flow only very gradually in the direction of the production well, meaning that they remain under formation conditions in the formation for a prolonged period. Degradation of the polymer results in a decrease in the viscosity. This either has to be taken into account through the use of a higher amount of polymer, or else it has to be accepted that the efficiency of the method will worsen. In each case, the economic viability of the method worsens. A multitude of mechanisms may be responsible for the degradation of the polymer. By means of suitable additives, the polymer degradation can be prevented or at least delayed according to the conditions.

In one embodiment of the invention, the aqueous formulation used comprises at least one oxygen scavenger. Oxygen scavengers react with oxygen which may possibly be present in the aqueous formulation and thus prevent the oxygen from being able to attack the polymer or polyether groups. Examples of oxygen scavengers comprise sulfites, for example Na₂SO₃, bisulfites, phosphites, hypophosphites or dithionites.

In a further embodiment of the invention, the aqueous formulation used comprises at least one free radical scavenger. Free-radical scavengers can be used to counteract the degradation of the polymer or of the surfactant containing polyether groups by free radicals. Compounds of this kind (free-radical scavengers) can form stable compounds with free radicals. Free-radical scavengers are known in principle to those skilled in the art. For example, they may be stabilizers selected from the group of sulfur compounds, secondary amines, sterically hindered amines, N-oxides, nitroso compounds, aromatic hydroxyl compounds or ketones. Examples of sulfur compounds include thiourea, substituted thioureas such as N,N′-dimethylthiourea, N,N′-diethylthiourea, N,N′-diphenylthiourea, thiocyanates, for example ammonium thiocyanate or potassium thiocyanate, tetramethylthiuram disulfide, or mercaptans such as 2-mercaptobenzothiazole or 2-mercaptobenzimidazole or salts thereof, for example the sodium salts, sodium dimethyldithiocarbamate, 2,2′-dithiobis(benzothiazole), 4,4′-thiobis(6-t-butyl-m-cresol). Further examples include phenoxazine, salts of carboxylated phenoxazine, carboxylated phenoxazine, methylene blue, dicyandiamide, guanidine, cyanamide, paramethoxyphenol, sodium salt of paramethoxyphenol, 2-methylhydroquinone, salts of 2-methylhydroquinone, 2,6-di-t-butyl-4-methylphenol, butylhydroxyanisole, 8-hydroxyquinoline, 2,5-di(t-amyl)-hydroquinone, 5-hydroxy-1,4-naphthoquinone, 2,5-di(t-amyl)hydroquinone, dimedone, propyl 3,4,5-trihydroxybenzoate, ammonium N-nitrosophenylhydroxylamine, 4-hydroxy-2,2,6,6-tetramethyloxypiperidine, N-(1,3-dimethylbutyl)-N′-phenyl-p-phenylenediamine or 1,2,2,6,6-pentamethyl-4-piperidinol. Preference is given to sterically hindered amines such as 1,2,2,6,6-pentamethyl-4-piperidinol and sulfur compounds, mercapto compounds, especially 2-mercaptobenzothiazole or 2-mercaptobenzimidazole or salts thereof, for example the sodium salts, and particular preference is given to 2-mercaptobenzothiazole or salts thereof.

In a further embodiment of the invention, the aqueous formulation used comprises at least one sacrificial reagent. Sacrificial reagents can react with free radicals and thus render them harmless. Examples include especially alcohols. Alcohols can be oxidized by free radicals, for example to ketones. Examples include monoalcohols and polyalcohols, for example 1-propanol, 2-propanol, propylene glycol, glycerol, butanediol or pentaerythritol.

In a further embodiment of the invention, the aqueous formulation used comprises at least one complexing agent. It is of course possible to use mixtures of various complexing agents. Complexing agents are generally anionic compounds which can complex especially divalent and higher-valency metal ions, for example Mg²⁺ or Ca²⁺. In this way, it is possible, for example, to prevent any unwanted precipitation. In addition, it is possible to prevent any polyvalent metal ions present from crosslinking the polymer by means of acidic groups present, especially COOH group. The complexing agents may especially be carboxylic acid or phosphonic acid derivatives. Examples of complexing agents include ethylenediaminetetraacetic acid (EDTA), ethylenediaminedisuccinic acid (EDDS), diethylenetriaminepentamethylenephosphonic acid (DTPMP), methylglycinediacetic acid (MGDA) or nitrilotriacetic acid (NTA). Of course, the corresponding salts of each may also be involved, for example the corresponding sodium salts. In a particularly preferred embodiment of the invention, MGDA is used as complexing agent.

As an alternative to or in addition to the abovementioned chelating agents, it is also possible to use polyacrylates.

In a further embodiment of the invention, the formulation comprises at least one organic cosolvent. These are preferably completely water-miscible solvents, but it is also possible to use solvents having only partial water miscibility. In general, the solubility should be at least 0.5 g/l, preferably at least 1 g/l. Examples include aliphatic C₄ to C₈ alcohols, preferably C₄ to C₆ alcohols, which may be substituted by 1 to 5, preferably 1 to 3, ethyleneoxy units to achieve sufficient water solubility. Further examples include aliphatic diols having 2 to 8 carbon atoms, which may optionally also have further substitution. For example, the cosolvent may be at least one selected from the group of 2-butanol, 2 methyl-1-propanol, butylglycol, butyldiglycol or butyltriglycol.

The concentration of the polymer in the aqueous formulation is fixed such that the aqueous formulation has the desired viscosity or mobility control for the end use. The viscosity of the formulation should generally be at least 5 mPas (measured at 25° C. and a shear rate of 7 s⁻¹), preferably at least 10 mPas.

According to the invention, the concentration of the polymer in the formulation is 0.02% to 2% by weight, based on the sum total of all the components of the aqueous formulation. The amount is preferably 0.05% to 1% by weight, more preferably 0.1% to 0.8% by weight and, for example, 0.1% to 0.4% by weight.

The formulation comprising the possible aqueous polymer can be prepared by initially charging the water, sprinkling the polymer in as a powder and mixing it with the water. Apparatuses for dissolving polymers and injecting the aqueous solutions into underground formations are known in principle to those skilled in the art.

The injecting of the aqueous formulation can be undertaken by means of customary apparatuses. The formulation can be injected into one or more injection wells by means of customary pumps. The injection wells are typically lined with steel tubes cemented in place, and the steel tubes are perforated at the desired point. The formulation enters the mineral oil formation from the injection well through the perforation. The pressure applied by means of the pumps, in a manner known in principle, is used to fix the flow rate of the formulation and hence also the shear stress with which the aqueous formulation enters the formation. The shear stress on entry into the formation can be calculated by the person skilled in the art in a manner known in principle on the basis of the Hagen-Poiseuille law, using the area through which the flow passes on entry into the formation, the mean pore radius and the volume flow rate. The average permeability of the formation can be found as described in a manner known in principle. Naturally, the greater the volume flow rate of aqueous polymer formulation injected into the formation, the greater the shear stress.

The rate of injection can be fixed by the person skilled in the art according to the conditions in the formation. Preferably, the shear rate on entry of the aqueous polymer formulation into the formation is at least 30 000 s⁻¹, preferably at least 60 000 s⁻¹ and more preferably at least 90 000 s⁻¹.

In one embodiment of the invention, the method of the invention is a flooding method in which a base and typically a complexing agent or a polyacrylate is used. This is typically the case when the proportion of polyvalent cations in the deposit water is low (100-400 ppm). An exception is sodium metaborate, which can be used as a base in the presence of significant amounts of polyvalent cations even without complexing agent.

The pH of the aqueous formulation here is generally at least 8, preferably at least 9, especially 9 to 13, preferably 10 to 12 and, for example, 10.5 to 11.

In principle, it is possible to use any kind of base with which the desired pH can be attained, and the person skilled in the art will make a suitable selection. Examples of suitable bases include alkali metal hydroxides, for example NaOH or KOH, or alkali metal carbonates, for example Na₂CO₃. In addition, the bases may be basic salts, for example alkali metal salts of carboxylic acids, phosphoric acid, or especially complexing agents comprising acidic groups in the base form, such as EDTANa₄.

Mineral oil typically also comprises various carboxylic acids, for example naphthenic acids, which are converted to the corresponding salts by the basic formulation. The salts act as naturally occurring surfactants and thus support the process of oil removal.

With complexing agents, it is advantageously possible to prevent unwanted precipitation of sparingly soluble salts, especially Ca and Mg salts, when the alkaline aqueous formulation comes into contact with the corresponding metal ions and/or aqueous formulations for the process comprising corresponding salts are used. The amount of complexing agents is selected by the person skilled in the art. It may, for example, be 0.1% to 4% by weight based on the sum total of all components of the aqueous formulation.

In a particularly preferred embodiment of the invention, however, a method of mineral oil production is employed in which no base (e.g. alkali metal hydroxides or alkali metal carbonates) is used.

In a preferred execution of the invention, it is a characteristic feature of the process that the production of mineral oil from underground mineral oil deposits is a surfactant flooding method or a surfactant/polymer flooding method and not an alkali/surfactant/polymer flooding method and not a flooding method in which Na₂CO₃ is injected as well.

In a particularly preferred execution of the invention, it is a characteristic feature of the process that the production of mineral oil from underground mineral oil deposits is a Winsor type III microemulsion flooding method or a Winsor type III microemulsion/polymer flooding method and not an alkali/Winsor type III microemulsion/polymer flooding method and not a flooding method in which Na₂CO₃ is injected as well.

Mineral oil is thus preferably produced from underground mineral oil deposits by the method of the invention by means of Winsor type III microemulsion flooding. In addition, the mineral oil deposit comprises carbonate rock. Illustrative compositions of carbonate rock can be found in example 5 on page 17 of WO 2015/173 339 A1. These compositions also form part of the subject matter of the present invention. Preferably, the deposit temperature is ≥50° C., preferably ≥65° C., and preferably <90° C. The salinity of the formation water is preferably ≥75 000 ppm of dissolved salts, preferably ≥100 000 ppm, more preferably ≥120 000 ppm, even more preferably ≥130 000 ppm, of dissolved salts (TDS).

The salts in the deposit water may especially be alkali metal salts and alkaline earth metal salts. Examples of typical cations include Na⁺, K⁺, Mg²⁺ and/or Ca²⁺, and examples of typical anions include chloride, bromide, hydrogencarbonate, sulfate or borate. According to the invention, the deposit water should include at least 100 ppm of divalent cations. The amount of alkaline earth metal ions may preferably be 100 to 53 000 ppm, more preferably 120 ppm to 20 000 ppm and even more preferably 150 to 6000 ppm.

In general, at least one or more than one alkali metal ions are present, especially at least Na⁺. In addition, it is also possible for alkaline earth metal ions to be present, in which case the weight ratio of alkali metal ions/alkaline earth metal ions is generally ≥2, preferably ≥3. Anions present are generally at least one or more than one halide ion(s), especially at least Cl⁻. In general, the amount of Cl⁻ is at least 50% by weight, preferably at least 80% by weight, based on the sum total of all the anions.

The pH of the formation water of the carbonate deposit is 3 to 10, preferably 5 to 9. One factor that affects the pH of the deposit is dissolved CO₂.

The concentration of all the surfactants together is preferably 0.05% to 2% by weight, based on the total amount of the aqueous formulation injected. The total surfactant concentration is preferably 0.06% to 1% by weight, more preferably 0.08% to 0.5% by weight.

In a further preferred embodiment of the invention, at least one organic cosolvent can be added to the surfactant mixture of the invention. These are preferably completely water-miscible solvents, but it is also possible to use solvents having only partial water miscibility. In general, the solubility should be at least 1 g/l, preferably at least 5 g/l. Examples include aliphatic C3 to C8 alcohols, preferably C4 to C6 alcohols, further preferably C3 to C6 alcohols, which may be substituted by 1 to 5, preferably 1 to 3, ethyleneoxy units to achieve sufficient water solubility. Further examples include aliphatic diols having 2 to 8 carbon atoms, which may optionally also have further substitution. For example, the cosolvent may be at least one selected from the group of 2-butanol, 2-methyl-1-propanol, butyl ethylene glycol, butyl diethylene glycol or butyl triethylene glycol.

In the context of the process according to the invention for tertiary mineral oil production, the use of the inventive surfactant mixture lowers the interfacial tension between oil and water to values of <0.1 mN/m, preferably to <0.05 mN/m, more preferably to <0.01 mN/m. Thus, the interfacial tension between oil and water is lowered to values in the range from 0.1 mN/m to 0.0001 mN/m, preferably to values in the range from 0.05 mN/m to 0.0001 mN/m, more preferably to values in the range from 0.01 mN/m to 0.0001 mN/m. The stated values relate to the prevailing deposit temperature.

It is possible for the aqueous saline surfactant formulation to include further surfactants (D) that are not identical to the surfactants (A), (B) or (C), and
are from the group of the alkylbenzenesulfonates, alpha-olefinsulfonates, internal olefinsulfonates, paraffinsulfonates, where the surfactants have 14 to 28 carbon atoms; and/or
are selected from the group of the alkyl ethoxylates and alkyl polyglucosides, where the particular alkyl radical has 8 to 18 carbon atoms.

For the surfactants (D), particular preference is given to alkyl polyglucosides which have been formed from primary linear fatty alcohols having 8 to 14 carbon atoms and have a glucosidation level of 1 to 2, and alkyl ethoxylates which have been formed from primary alcohols having 10 to 18 carbon atoms and have an ethoxylation level of 5 to 50.

The amount of the surfactants (A) and (B) and—if present—(C) based on the total amount of all the surfactants in the surfactant mixture is preferably at least 25% by weight, further preferably at least 50% by weight, even further preferably more than 50% by weight, even more preferably still at least 60% by weight, even more preferably at least 70% by weight, more preferably at least 80% by weight, even more preferably at least 90% by weight and especially 100% by weight (composed solely of (A), (B) and optionally (C)).

The present invention further provides a concentrate comprising a surfactant mixture as specified above, wherein the concentrate comprises 20% by weight to 90% by weight of the surfactant mixture, 5% to 40% by weight of water and 5% to 40% by weight of a cosolvent, based in each case on the total amount of the concentrate, wherein the concentrate of the surfactant mixture composed of ionic surfactant (A) of the general formula (I) and anionic surfactant (B) of the general formula (II) may be present in any molar ratio, but is preferably present in the ratio specified for the method of the invention.

The water may be saline water as set out in detail above.

Accordingly, the aqueous saline surfactant formulation injected may be obtained in the method of the invention the surfactant mixture by mixing a concentrate with surfactant mixture or by mixing in individual concentrates.

Accordingly, the provision of the surfactants composed of ionic surfactant (A) of the general formula (I) and anionic surfactant (B) of the general formula (II) is possible, for example, in the form of concentrates. For example, the ionic surfactant (A) of the general formula (I) may be supplied as a concentrate, where the concentrate comprises 20% by weight to 90% by weight of surfactant (A), 5% by weight to 40% by weight of water and 5% by weight to 40% by weight of a cosolvent, based in each case on the total amount of the concentrate. The same applies to the anionic surfactant (B) of the general formula (II). It may be supplied as a concentrate, where the concentrate comprises 20% by weight to 90% by weight of surfactant (B), 5% by weight to 40% by weight of water and 5% by weight to 40% by weight of a cosolvent, based in each case on the total amount of the concentrate. For the method of the invention, the two concentrates may be added to the injection water in the desired ratio and dissolved.

Therefore, the present invention further provides a concentrate comprising, based in each case on the total amount of the concentrate,

20% by weight to 90% by weight of at least one ionic surfactant (A) of the general formula (I) as specified above or at least one anionic surfactant (B) of the general formula (II) as specified above, or a surfactant mixture as specified above, where the molar ratio of ionic surfactant (A) to anionic surfactant (B) may be as desired,

5% to 40% by weight of water and

5% to 40% by weight of a cosolvent.

In respect of the surfactant mixture, the ionic surfactant (A) and the anionic surfactant (B), and also surfactant (C), what was also set out above in the context of the method of the invention is likewise applicable to the concentrate of the invention.

The cosolvent is preferably selected from the group of the aliphatic alcohols having 3 to 8 carbon atoms or from the group of the alkyl monoethylene glycols, the alkyl diethylene glycols or the alkyl triethylene glycols, where the alkyl radical is an aliphatic hydrocarbyl radical having 3 to 6 carbon atoms. Further preferably, the concentrate of the invention at 20° C. is free-flowing or pumpable, and at 40° C. has a viscosity of <5000 mPas at 10 s⁻¹.

Accordingly, it is preferable that the cosolvent is selected from the group of the aliphatic alcohols having 3 to 8 carbon atoms or from the group of the alkyl monoethylene glycols, the alkyl diethylene glycols or the alkyl triethylene glycols, where the alkyl radical is an aliphatic hydrocarbyl radical having 3 to 6 carbon atoms.

It is further preferable that the concentrate at 20° C. is free-flowing and at 50° C. has a viscosity of <10 000 mPas at 10 s⁻¹.

The concentrate may further comprise alkali metal chloride and diglycolic acid dialkali metal salt. Optionally, it also comprises chloroacetic acid alkali metal salt, glycolic acid alkali metal salt, water and/or a cosolvent. The cosolvent is, for example, butyl ethylene glycol, butyl diethylene glycol or butyl triethylene glycol.

The concentrate preferably comprises 0.5% to 15% by weight of a mixture comprising NaCl and diglycolic acid disodium salt, where NaCl is present in excess relative to diglycolic acid disodium salt.

Further preferably, the concentrate comprises butyl diethylene glycol as cosolvent.

The present invention further relates to the use of a surfactant mixture or of a concentrate of the invention for production of mineral oil from underground mineral oil deposits.

The present invention further relates to the use of a surfactant formulation as specified above for production of mineral oil from underground mineral oil deposits, especially under conditions as described herein.

In respect of the surfactant mixture, what was set out above in the context of the method of the invention is likewise applicable to the use of the invention.

Mineral oil is preferably produced from underground mineral oil deposits by the method of the invention by means of Winsor type III microemulsion flooding. In addition, the mineral oil deposit comprises carbonate rock.

S. N. Ehrenberg and P. H. Nadeau compare sandstone deposits and carbonate deposits with regard to their porosity and deposit depth (AAPG Bulletin, V. 89, No. 4 (April 2005), pages 435-445). Carbonate deposits have lower porosities on average than sandstone deposits. Moreover, there may be ‘fractures’ with correspondingly high permeability, while there are simultaneously what are called matrix blocks with lower permeability. Carbonate deposits may thus have regions having permeabilities of 1-100 mD (millidarcies) and regions having permeabilities of 10-100 mD, and also regions having permeabilities of >>100 mD. There are additionally also deposits having a small number of fractures and relatively homogeneous matrix regions. For example, a carbonate deposit may have a porosity of 10-40% (preferably 12-35%) and permeabilities of 1-4000 mD (preferably 2-2000 mD, more preferably 5-500 mD).

Further descriptions of carbonate deposits can also be found in the two following publications:
Archie, Gustave Erdman. “Classification of carbonate reservoir rocks and petrophysical considerations.” Aapg Bulletin 36.2 (1952): 278-298.
Lucia, F. Jerry. Carbonate reservoir characterization: an integrated approach. Springer Science & Business Media, 2007.

The composition of carbonate rocks may vary. As well as calcite and/or dolomite, these also comprise, for example, ankerite, feldspar, quartz, clay minerals (e.g. kaolin, illite, smectite, chlorite), halites, iron oxides, pyrite, gypsum and/or epsomite. Preference is given to deposits having a high calcite content (>90%, more preferably >95%) and a low quartz content (<5%, more preferably <2%) and a low clay mineral content (<5%, more preferably <2%). For example, a preferred deposit could have 98% calcite, 1% dolomite and 1% halite. Further illustrative compositions of carbonate rock can be found, for example, in table 2 of Colloids and Surfaces A: Physicochem. Eng. Aspects 450 (2014) 1-8 or in example 5 on page 17 of WO 2015/173 339 A1. The present invention also provides for the selection of surfactant mixtures depending on rock compositions, temperature and salinity. The deposit temperature is preferably ≥90° C., more preferably 100° C., even more preferably ≥110° C. The salinity of the formation water is preferably ≥50 000 ppm, more preferably ≥100 000 ppm and further preferably ≥210 000 ppm TDS.

More particularly, the use of the invention relates to a method according to the present invention, wherein what has been set out above in respect of the method of the invention is correspondingly applicable to the use of the invention.

### EXPERIMENTAL EXAMPLES

### Synthesis Examples

The following examples are intended to illustrate the invention and its advantages in detail:

Preparation of the Anionic Surfactants (A) and (B) and (C):

Abbreviations Used:

EO ethyleneoxy

PO propyleneoxy

For the synthesis, the following alcohols were used:

| Alcohol | Description |
|---|---|
| C₁₆C₁₈—OH | Commercially available tallow fat alcohol mixture consisting of linear |
| | saturated primary C₁₆H₃₃—OH and C₁₈H₃₇—OH in a molar ratio of |
| | about 30:70 |
| C16—OH | Commercially available aliphatic alcohol consisting of linear saturated |
| | primary C₁₆H₃₃—OH |

1 a) C16C18-10 EO—CH₂CO₂Na

corresponds to the mixture of anionic surfactant A to the anionic surfactant B in a molar ratio of about 30:70, consisting of anionic surfactant (A) of the general formula (I) R¹—O—(CH₂CH₂O)ₒ—(CH₂)ₚ—Y⁻M⁺ with R¹=n-C₁₆H₃₃, o=10, p=1, Y=CO₂ and M=Na and anionic surfactant (B) of the general formula (II) R²—O—(CH₂CH₂O)ₒ—(CH₂)ₚ—Y⁻M⁺ with R²=n-C₁₈H₃₇, o=10, p=1, Y=CO₂ and M=Na.

A 2 l pressure autoclave with anchor stirrer was initially charged with 392.4 g (1.5 mol) of C16C18 alcohol and the stirrer was switched on. Thereafter, 4.2 g of 50% aqueous KOH solution (0.038 mol of KOH, 2.1 g of KOH) was added, a reduced pressure of 25 mbar was applied, and the mixture was heated to 120° C. and kept there for 120 min, in order to distill off the water. The mixture was purged three times with N₂. Thereafter, the vessel was tested for pressure retention and adjusted to 1.0 bar gauge (2.0 bar absolute), the mixture was heated to 130° C. and then the pressure was set to 2.3 bar absolute. 660.8 g (15 mol) of ethylene oxide was metered in at 130° C. within 7 h; pₘₐₓ was 6.0 bar absolute. The mixture was left to react for 6 h until the pressure was constant, cooled down to 100° C. and decompressed to 1.0 bar absolute. A vacuum of <10 mbar was applied and residual oxide was drawn off for 2 h. The vacuum was broken with N₂ and the product was decanted at 80° C. under N₂. Analysis (mass spectrum, GPC, 1H NMR in CDCl₃, 1H NMR in MeOD) confirmed the average composition C16C18-10 EO—H.

A 250 ml flange reactor with a three-level beam stirrer was charged with 160 g (0.228 mol, 1.0 eq) of C16C18-10 EO—H comprising 0.006 mol of C16C18-10 EO—K and 36.6 g (0.308 mol, 1.35 eq) of chloroacetic acid sodium salt (98% purity), and the mixture was stirred at 45° C. under standard pressure at 400 revolutions per minute for 15 min. Thereafter, the following procedure was conducted eight times: 1.54 g (0.0384 mol, 0.1686 eq) of NaOH microprills (diameter 0.5-1.5 mm) was introduced, a vacuum of 30 mbar absolute was applied to remove the water of reaction, the mixture was stirred for 50 min, and then the vacuum was broken with N₂. A total of 12.3 g (0.308 mol, 1.35 eq) of NaOH microprills was added over a period of about 7 h. Over the first hour of this period, the speed of rotation was increased to about 1000 revolutions per minute. This was followed by continued stirring at 45° C. and at 45 mbar absolute for 45 min and at 45° C. and 60 mbar absolute for 15 h. The vacuum was broken with N₂ and the experiment was decanted out (yield >95%).

This gave a liquid which was white-yellowish and viscous at 20° C. The pH (5% in water) was 8.9. The water content was 1.5%. The molar proportion of chloroacetic acid sodium salt is about 2 mol %. The NaCl content is about 8.7% by weight. The OH number of the reaction mixture is 5.8 mg KOH/g. The molar proportion of glycolic acid sodium salt is about 2 mol %. In addition, a 1H NMR spectrum was created (with and without trichloroacetyl isocyanate shift reagent). The carboxymethylation level is 93%. The desired structure was confirmed.

A surfactant concentrate was prepared by stirring 106.9 g of the above crude carboxylate at 25° C. 52.7 g of butyl diethylene glycol and 51.1 g of water were added. The surfactant content is 42 percent by weight. Further details on the properties of the surfactant concentrate can be found in table 5.

1 b) C16C18-8 EO—CH₂CO₂Na

corresponds to the mixture of anionic surfactant A to the anionic surfactant B in a molar ratio of about 30:70, consisting of anionic surfactant (A) of the general formula (I) R¹—O—(CH₂CH₂O)ₒ—(CH₂)ₚ—Y⁻M⁺ with R¹=n-C₁₆H₃₃, o=8, p=1, Y=CO₂ and M=Na and anionic surfactant (B) of the general formula (II) R²—O—(CH₂CH₂O)ₒ—(CH₂)ₚ—Y⁻M⁺ with R²=n-C₁₈H₃₇, o=8, p=1, Y=CO₂ and M=Na.

A 2 l pressure autoclave with anchor stirrer was initially charged with 392.4 g (1.5 mol) of C16C18 alcohol and the stirrer was switched on. Thereafter, 3.7 g of 50% aqueous KOH solution (0.029 mol of KOH, 1.65 g of KOH) was added, a reduced pressure of 25 mbar was applied, and the mixture was heated to 120° C. and kept there for 120 min, in order to distill off the water. The mixture was purged three times with N₂. Thereafter, the vessel was tested for pressure retention and adjusted to 1.0 bar gauge (2.0 bar absolute), the mixture was heated to 130° C. and then the pressure was set to 2.4 bar absolute. 528.6 g (12 mol) of ethylene oxide was metered in at 130° C. within 7 h; pₘₐₓ was 6.0 bar absolute. The mixture was left to react for 6 h until the pressure was constant, cooled down to 100° C. and decompressed to 1.0 bar absolute. A vacuum of <10 mbar was applied and residual oxide was drawn off for 2 h. The vacuum was broken with N₂ and the product was decanted at 80° C. under N₂. Analysis (mass spectrum, GPC, 1H NMR in CDCl₃, 1H NMR in MeOD) confirmed the average composition C16C18-8 EO—H.

A 250 ml flange reactor with a three-level beam stirrer was charged with 148.2 g (0.241 mol, 1.0 eq) of C16C18-8 EO—H comprising 0.005 mol of C16C18-8 EO—K and 37.7 g (0.317 mol, 1.35 eq) of chloroacetic acid sodium salt (98% purity), and the mixture was stirred at 45° C. under standard pressure at 400 revolutions per minute for 15 min. Thereafter, the following procedure was conducted eight times: 1.59 g (0.0397 mol, 0.1688 eq) of NaOH microprills (diameter 0.5-1.5 mm) was introduced, a vacuum of 30 mbar absolute was applied to remove the water of reaction, the mixture was stirred for 50 min, and then the vacuum was broken with N₂. A total of 12.7 g (0.317 mol, 1.35 eq) of NaOH microprills was added over a period of about 7 h. Over the first hour of this period, the speed of rotation was increased to about 1000 revolutions per minute. This was followed by continued stirring at 45° C. and at 45 mbar absolute for 45 min and at 45° C. and 60 mbar absolute for 15 h. The vacuum was broken with N₂ and the experiment was decanted out (yield >95%).

This gave a liquid which was white-yellowish and viscous at 20° C. The pH (5% in water) was 8.8. The water content was 1.5%. The molar proportion of chloroacetic acid sodium salt is about 2 mol %. The NaCl content is about 9.2% by weight. The OH number of the reaction mixture is 5.8 mg KOH/g. The molar proportion of glycolic acid sodium salt is about 2 mol %. In addition, a 1H NMR spectrum was created (with and without trichloroacetyl isocyanate shift reagent). The carboxymethylation level is 93%. The desired structure was confirmed. 134 g of the above crude carboxylate was stirred at 25° C. 67 g of butyl diethylene glycol and 67 g of water were added. The surfactant content is 46 percent by weight.

1 c) C16C18-9 EO—CH₂CO₂Na

C16C18-9 EO—CH₂CO₂Na is prepared analogously to 1b).

1 d) C16C18-7 EO—CH₂CO₂Na

C16C18-7 EO—CH₂CO₂Na is prepared analogously to 1b).

1 e) C16-7 EO—CH₂CO₂Na

C16-7 EO—CH₂CO₂Na is prepared analogously to 1d), except that C16 alcohol is used as starting material rather than C16C18 alcohol.

2 a) C16C18-7 PO—10 EO—CH₂CO₂Na

corresponds to the anionic surfactant (C) of the general formula (III) R³—O—(CH₂CHCH₃O)ₙ(CH₂CH₂O)ₒ—(CH₂)ₚ—Y⁻M⁺ with R³=C₁₆H₃₃/C₁₈H₃₇, n=7, o=10, p=1, Y=CO₂ and M=Na.

A 2 l pressure autoclave with anchor stirrer was initially charged with 304 g (1.19 mol) of C16C18 alcohol and the stirrer was switched on. Thereafter, 4.13 g of 50% aqueous KOH solution (0.037 mol of KOH, 2.07 g of KOH) was added, a reduced pressure of 25 mbar was applied, and the mixture was heated to 100° C. and kept there for 120 min, in order to distill off the water. The mixture was purged three times with N₂. Thereafter, the vessel was tested for pressure retention and adjusted to 1.0 bar gauge (2.0 bar absolute), the mixture was heated to 130° C. and then the pressure was set to 2.0 bar absolute. At 150 revolutions per minute, 482 g (8.31 mol) of propylene oxide was metered in at 130° C. within 6 h; pₘₐₓ was 6.0 bar absolute. The mixture was stirred at 130° C. for a further 2 h. 522 g (11.9 mol) of ethylene oxide was metered in at 130° C. within 10 h; pₘₐₓ was 5.0 bar absolute. The mixture was left to react for 1 h until the pressure was constant, cooled down to 100° C. and decompressed to 1.0 bar absolute. A vacuum of <10 mbar was applied and residual oxide was drawn off for 2 h. The vacuum was broken with N₂ and the product was decanted at 80° C. under N₂. Analysis (mass spectrum, GPC, 1H NMR in CDCl₃, 1H NMR in MeOD) confirmed the average composition C16C18-7 PO—10 EO—H.

A 250 ml flange reactor with a three-level beam stirrer was charged with 165.3 g (0.150 mol, 1.0 eq) of C16C18-7 PO—10 EO—H comprising 0.005 mol of C16C18-7 PO—10 EO—K and 24.1 g (0.203 mol, 1.35 eq) of chloroacetic acid sodium salt (98% purity), and the mixture was stirred at 45° C. under standard pressure at 400 revolutions per minute for 15 min. Thereafter, the following procedure was conducted eight times: 1.02 g (0.0253 mol, 0.1688 eq) of NaOH microprills (diameter 0.5-1.5 mm) was introduced, a vacuum of 30 mbar was applied to remove the water of reaction, the mixture was stirred for 50 min, and then the vacuum was broken with N₂. A total of 8.1 g (0.203 mol, 1.35 eq) of NaOH microprills was added over a period of about 6.5 h. Over the first hour of this period, the speed of rotation was increased to about 1000 revolutions per minute. Thereafter, stirring was continued at 45° C. and at 30 mbar for 3 h. The vacuum was broken with N₂ and the experiment was decanted out (yield >95%).

This gave a liquid which was white-yellowish and viscous at 20° C. The pH (5% in water) was 7.5.

The water content was 1.5%. The molar proportion of chloroacetic acid sodium salt is about 2 mol %. The NaCl content is about 6.0% by weight. The OH number of the reaction mixture is 8.0 mg KOH/g. The molar proportion of glycolic acid sodium salt is about 3 mol %. In addition, a 1H NMR spectrum was created (with and without trichloroacetyl isocyanate shift reagent). The carboxymethylation level is 85%. The desired structure was confirmed. 99 g of butyl diethylene glycol and 99 g of water were added. The surfactant content is 45 percent by weight.

2 b) C16C18-7 PO—15 EO—CH₂CO₂Na

corresponds to the anionic surfactant (C) of the general formula (III) R³—O—(CH₂CHCH₃O)ₙ(CH₂CH₂O)ₒ—(CH₂)ₚ—Y⁻M⁺ with R³=C₁₆H₃₃/C₁₈H₃₇, n=7, o=15, p=1, Y=CO₂ and M=Na.

A 2 l pressure autoclave with anchor stirrer was initially charged with 261.6 g (1.0 mol) of C16C18 alcohol and the stirrer was switched on. Thereafter, 4.5 g of 50% aqueous KOH solution (0.04 mol of KOH, 2.25 g of KOH) was added, a reduced pressure of 25 mbar was applied, and the mixture was heated to 100° C. and kept there for 120 min, in order to distill off the water. The mixture was purged three times with N₂. Thereafter, the vessel was tested for pressure retention and adjusted to 1.0 bar gauge (2.0 bar absolute), the mixture was heated to 135° C. and then the pressure was set to 2.2 bar absolute. At 125 revolutions per minute, 412.4 g (7.1 mol) of propylene oxide was metered in at 135° C. within 6 h; pₘₐₓ was 6.0 bar absolute. The mixture was stirred at 135° C. for a further 4 h. 674 g (15.3 mol) of ethylene oxide was metered in at 135° C. within 8 h; pₘₐₓ was 5.0 bar absolute. The mixture was left to react for 6 h until the pressure was constant, cooled down to 100° C. and decompressed to 1.0 bar absolute. A vacuum of <10 mbar was applied and residual oxide was drawn off for 2 h. The vacuum was broken with N₂ and the product was decanted at 80° C. under N₂. Analysis (mass spectrum, GPC, 1H NMR in CDCl₃, 1H NMR in MeOD) confirmed the average composition C16C18-7 PO—15 EO—H.

A 750 ml flange reactor with a three-level beam stirrer was charged with 400 g (0.30 mol, 1.0 eq) of C16C18-7 PO—15 EO—H comprising 0.012 mol of C16C18-7 PO—15 EO—K, which was stirred at 70° C. (750 revolutions per minute). The following procedure was subsequently conducted 12 times: 5.34 g of 50% aqueous sodium hydroxide solution was metered in at 70° C. and a reduced pressure of 12 mbar absolute was applied at 70° C. for 15 minutes for removal of water, the reduced pressure was broken again by adding nitrogen, then 3.94 g of 80% chloroacetic acid in water was added at 70° C. and a reduced pressure of 12 mbar absolute was applied at 70° C. for 15 minutes for removal of water, and the reduced pressure was broken again by adding nitrogen. Thus, a total of 64.10 g (0.80 mol, 32.05 g of NaOH, 2.67 eq) of 50% aqueous sodium hydroxide solution and 47.32 g (0.40 mol, 1.33 eq) of 80% chloroacetic acid in water were metered in at 70° C. within 7 h. This was followed by stirring for a further 20 minutes. The product of the experiment was discharged (yield >95%).

This gave a liquid which was white-yellowish and viscous at 20° C. The pH (5% in water) was 12. The water content was 0.45%. The molar proportion of chloroacetic acid sodium salt is about 2 mol %. The NaCl content is about 5.1% by weight. The OH number of the reaction mixture is 8.3 mg KOH/g. The molar proportion of glycolic acid sodium salt is about 3.5 mol %. In addition, a 1H NMR spectrum was created (with and without trichloroacetyl isocyanate shift reagent). The carboxymethylation level is 83%. The desired structure was confirmed.

365 g of the above crude carboxylate was stirred at 25° C. The pH was adjusted to pH=7.6 by addition of acetic acid. 182.5 g of butyl diethylene glycol and 182.5 g of water were added. The surfactant content of the concentrate is about 45 percent by weight.

Application Tests.

Production of the Aqueous Salt Solutions

Three different aqueous salt solutions were produced. For this purpose, salts were weighed out in distilled water and dissolved by stirring at 20° C. Finally, the pH was adjusted, and the salt solution was stored in a closed vessel and checked for clarity for several days:
Synthetic seawater with TDS 43 910 ppm comprising 30.53 g/l NaCl, 2.11 g/l CaCl₂×2 H₂O, 13.97 g/l MgCl₂×6 H₂O, 5.03 g Na₂SO₄, 0.21 g NaHCO₃— pH adjusted to 8.0
Illustrative synthetic deposit water I with TDS 138 656 ppm, comprising 103.50 g/l NaCl, 35.59 g/l CaCl₂×2 H₂O, 17.14 g/l MgCl₂×6 H₂O, 0.25 g NaHCO₃— pH adjusted to 7.0
Illustrative synthetic deposit water II with TDS 234 370 ppm, comprising 171.99 g/l NaCl, 69.06 g/l CaCl₂×2 H₂O, 20.33 g/l MgCl₂×6 H₂O, 0.41 g Na₂SO₄, 0.29 g NaHCO₃— pH adjusted to 6.0
Illustrative synthetic deposit water III with TDS 209 684 ppm, comprising 164.147 g/l NaCl, 48.239 g/l CaCl₂×2 H₂O, 16.971 g/l MgCl₂×6 H₂O, 1.150 g Na₂SO₄— pH adjusted to 6.9
Illustrative synthetic deposit water X produced by blending deposit water II with distilled water or by gently distilling water off to salinities of TDS 138 000 ppm, TDS 160 000 ppm, TDS 180 000 ppm, TDS 199 317 ppm, TDS 220 000 ppm and TDS 240 000 ppm

Determination of Solubility

The surfactants were dissolved in saline water in the particular concentration to be examined. In order to avoid degradation of the surfactants by oxygen at high temperatures, NaMBT and Na₂SO₃ were used as free-radical scavenger and as oxygen scavenger. An argon atmosphere was additionally employed, and the aqueous surfactant solutions were freed of oxygen by introducing argon for 30 minutes. A screwtop glass vessel approved for pressures up to 5 bar absolute was used.

The surfactants were stirred in the particular concentration to be examined in saline water having the respective salt composition at 20-30° C. for 30 min. For surfactant mixtures, by way of example, the ionic surfactant (A) of the general formula (I) (optionally in the form of a concentrate) was dissolved in the desired saltwater (that comprised free-radical scavenger and oxygen scavenger) in a first vessel. In a second vessel, the anionic surfactant (B) of the general formula (II) (optionally in the form of a concentrate) was dissolved in the desired saltwater (that comprised free-radical scavenger and oxygen scavenger). Subsequently, the two solutions were combined at 20-30° C. and then heated to the target temperature. Alternatively, the ionic surfactant (A) of the general formula (I) and the anionic surfactant (B) of the general formula (II) were pre-dissolved in demineralized water or low-salinity water (<10 000 ppm) (addition in the form of the concentrated individual surfactants or as a concentrated mixture), and then mixed with a saltwater solution (that comprised free-radical scavenger and oxygen scavenger); only in exceptional cases was the surfactant dissolved in water, the pH adjusted if required to a range from 6 to 8 by addition of aqueous hydrochloric acid, and corresponding amounts of respective salt dissolved at 20° C. This was followed by heating.

Thereafter, the mixture was heated stepwise until turbidity or a phase separation set in. This was followed by cautious cooling, and the point at which the solution became clear or scattering became slight again was noted. This was recorded as the cloud point.

At particular fixed temperatures, the appearance of the surfactant solution in saline water was noted. Clear solutions or solutions which have slight scatter and become somewhat lighter in color again through gentle shear (but do not foam with time) are regarded as acceptable. Said slightly scattering surfactant solutions were filtered through a filter having pore size 2 mm. No removal at all was found.

The figures for the amount of surfactant were reported as grams of active substance (calc. surfactant content 100%) per liter of saltwater.

Determination of Phase Characteristics

The surfactant solutions (10 g of surfactant based on active content in 1 liter of the aqueous salt solution comprising 50 ppm of Na₂SO₃ and 20 ppm of NaMBT) that have been produced for the above determinations of solubility were admixed with a particular amount of oil (water-oil ratio of 4:1, or 1:1 based on volume) and stored under an argon atmosphere in a sealable graduated vessel at 125° C. for seven or 14 days. During this time, the vessels were inverted and returned to the upright position once per day. It was noted from the gradation whether emulsions or microemulsions had formed. In the case of mobile middle phases (Winsor type III microemulsion), the SP* or SP_{O} was determined (see paragraph below).

Determination of Interfacial Tension

The interfacial tension between water and oil was determined in a known manner by means of the measurement of the solubilization parameter SP*. The determination of the interfacial tension via the determination of the solubilization parameter SP* is a method for approximate determination of the interfacial tension which is accepted in the technical field. The solubilization parameter SP* indicates how many ml of oil are dissolved per ml of surfactant used in a microemulsion (Winsor type III). The interfacial tension (IFT) σ can be calculated therefrom via the approximate formula IFT≈0.3/[(SP*)²], if equal volumes of water and oil are used (C. Huh, J. Coll. Interf. Sc., Vol. 71, No. 2 (1979)).

If different volumes of water and oil were used, the solubilization parameter SP_{O} was determined. This indicates how much oil relative to amount of surfactant used was microemulsified in the middle phase (Winsor type III microemulsion). Using the above equation, it is analogously possible to estimate the interfacial tension. For unbalanced Winsor type III microemulsions, it is possible to work out SP* via the formula 2/[SP*]=1/[SP_{O}]+1/[SP_{W}] (S. Gosh, R. T. Johns, Langmuir 2016, 32, 8969-8979). Interfacial tension can in turn be calculated via the above approximate formula IFT≈0.3/[(SP*)²].

Alternatively, interfacial tensions of crude oil with respect to saline water were determined in the presence of the surfactant solution at a temperature by the spinning drop method on an SVT20 from DataPhysics. For this purpose, an oil droplet was injected into a capillary filled with saline surfactant solution at temperature and the expansion of the droplet at approximately 4500 revolutions per minute was observed and the evolution of the interfacial tension with time was noted. The interfacial tension IFT (or s_{II}) is calculated—as described by Hans-Dieter Dörfler in “Grenzflächen und kolloid-disperse Systeme” [Interfaces and Colloidally Disperse Systems], Springer Verlag Berlin Heidelberg 2002—by the following formula from the cylinder diameter d_{z}, the speed of rotation w, and the density differential:

(d₁−d₂): s_{II}=0.25·d_{z}³·w2·(d₁−d₂).

The figures for the amount of surfactant were reported as grams of active substance (calc. surfactant content 100%) per liter of saltwater.

Specification of API Gravity

The API gravity (American Petroleum Institute gravity) is a conventional unit of density commonly used in the USA for crude oils. It is used globally for characterization and as a quality standard for crude oil. The API gravity is calculated from the relative density pᵣₑₗ of the crude oil at 60° F. (15.56° C.), based on water, using

API gravity=(141.5/pᵣₑₗ)−131.5.

The test results for solubility and for interfacial tension are shown below.

TABLE 1
Interfacial tension after 30 min with surfactant mixture of anionic surfactant
(A) of the general formula (I) and anionic surfactant (B) of the general formula
(II) on crude oil with API gravity 33 at 80° C. and various salinities

| | | | | Solubility of |
|---|---|---|---|---|
| | Surfactant formulation with 10 g/l | | | the surfactant |
| Example | of active substance in salt solution | Salt solution | IFT at 80° C. | formulation at 80° C. |
| 1 | 100 mol % of C16C18-10EO-CH₂CO₂Na^{b} | Salt content | 0.054 mN/m | Dissolves to give |
| | (ratio of C16-10EO-CH₂CO₂Na^{c} to | 138 000 ppm | | clear solution |
| | C18-10EO-CH₂CO₂Na^{d} is 30:70 | (deposit water X) | | |
| | on a molar basis) | | | |
| 2 | 100 mol % of C16C18-10EO-CH₂CO₂Na^{b} | Salt content | 0.0096 mN/m | Dissolves to give |
| | (ratio of C16-10EO-CH₂CO₂Na^{c} to | 240 000 ppm | | clear solution |
| | C18-10EO-CH₂CO₂Na^{d} is 30:70 | (deposit water X) | | |
| | on a molar basis) | | | |
| 3 | 60 mol % of C16C18-10EO-CH₂CO₂Na^{b} | Salt content | 0.0015 mN/m | Dissolves to give |
| | (ratio of C16-10EO-CH₂CO₂Na^{c} | 138 000 ppm | | clear solution |
| | to C18-10EO-CH₂CO₂Na^{d} is 30:70 | (deposit water X) | | |
| | on a molar basis) to 40 mol % of | | | |
| | C16C18-7PO-10EO-CH₂CO₂Naⁱ | | | |
| 4 | 70 mol % of C16C18-10EO-CH₂CO₂Na^{b} | Salt content | 0.0082 mN/m | Dissolves to give |
| | (ratio of C16-10EO-CH₂CO₂Na^{c} | 138 000 ppm | | clear solution |
| | to C18-10EO-CH₂CO₂Na^{d} is 30:70 | (deposit water X) | | |
| | on a molar basis) to 30 mol % of | | | |
| | C16C18-7PO-10EO-CH₂CO₂Naⁱ | | | |
| 5 | 78 mol % of C16C18-10EO-CH₂CO₂Na^{b} | Salt content | 0.0022 mN/m | Dissolves to give |
| | (ratio of C16-10EO-CH₂CO₂Na^{c} | 160 000 ppm | | clear solution |
| | to C18-10EO-CH₂CO₂Na^{d} is 30:70 | (deposit water X) | | |
| | on a molar basis) to 22 mol % of | | | |
| | C16C18-7PO-10EO-CH₂CO₂Naⁱ | | | |
| 6 | 86 mol % of C16C18-10EO-CH₂CO₂Na^{b} | Salt content | 0.0099 mN/m | Dissolves to give |
| | (ratio of C16-10EO-CH₂CO₂Na^{c} | 180 000 ppm | | clear solution |
| | to C18-10EO-CH₂CO₂Na^{d} is 30:70 | (deposit water X) | | |
| | on a molar basis) to 14 mol % of | | | |
| | C16C18-7PO-10EO-CH₂CO₂Naⁱ | | | |
| 7 | 93 mol % of C16C18-10EO-CH₂CO₂Na^{b} | Salt content | 0.0043 mN/m | Dissolves to give |
| | (ratio of C16-10EO-CH₂CO₂Na^{c} | 199 317 ppm | | clear solution |
| | to C18-10EO-CH₂CO₂Na^{d} is 30:70 | (deposit water X) | | |
| | on a molar basis) to 7 mol % of | | | |
| | C16C18-7PO-10EO-CH₂CO₂Naⁱ | | | |
| 8 | 93 mol % of C16C18-10EO-CH₂CO₂Na^{b} | Salt content | 0.0084 mN/m | Dissolves to give |
| | (ratio of C16-10EO-CH₂CO₂Na^{c} | 220 000 ppm | | clear solution |
| | to C18-10EO-CH₂CO₂Na^{d} is 30:70 | (deposit water X) | | |
| | on a molar basis) to 7 mol % of | | | |
| | C16C18-7PO-10EO-CH₂CO₂Naⁱ | | | |
| 9 | 86 mol % of C16C18-10EO-CH₂CO₂Na^{b} | Salt content | 0.0067 mN/m | Dissolves to give |
| | (ratio of C16-10EO-CH₂CO₂Na^{c} | 199 317 ppm | | clear solution |
| | to C18-10EO-CH₂CO₂Na^{d} is 30:70 | (deposit water X) | | |
| | on a molar basis) to 14 mol % of | | | |
| | C16C18-7PO-10EO-CH₂CO₂Naⁱ | | | |
| 10 | 78 mol % of C16C18-10EO-CH₂CO₂Na^{b} | Salt content | 0.0044 mN/m | Dissolves to give |
| | (ratio of C16-10EO-CH₂CO₂Na^{c} | 180 000 ppm | | clear solution |
| | to C18-10EO-CH₂CO₂Na^{d} is 30:70 | (deposit water X) | | |
| | on a molar basis) to 22 mol % of | | | |
| | C16C18-7PO-10EO-CH₂CO₂Naⁱ | | | |
| 11 | 78 mol % of C16C18-10EO-CH₂CO₂Na^{b} | Salt content | 0.0057 mN/m | Dissolves to give |
| | (ratio of C16-10EO-CH₂CO₂Na^{c} | 199 317 ppm | | clear solution |
| | to C18-10EO-CH₂CO₂Na^{d} is 30:70 | (deposit water X) | | |
| | on a molar basis) to 22 mol % of | | | |
| | C16C18-7PO-10EO-CH₂CO₂Naⁱ | | | |

^{b}from ex. 1a) [corresponds to the mixture of anionic surfactant A to the anionic surfactant B in a molar ratio of about 30:70, consisting of anionic surfactant (A) of the general formula (I) R¹—O—(CH₂CH₂O)ₒ—(CH₂)ₚ—Y⁻ M⁺ with R¹ = n-C₁₆H ₃₃, o = 10, p = 1, Y = CO₂ and M = Na and anionic surfactant (B) of the general formula (II) R²—O—(CH₂CH₂O)ₒ—(CH₂)ₚ—Y⁻ M⁺ with R² = n-C₁₈H₃₇, o = 10, p = 1, Y = CO₂ and M = Na]
^{c}corresponds to anionic surfactant (A) of the general formula (I) R¹—O—(CH₂CH₂O)ₒ—(CH₂)ₚ—Y⁻ M⁺ with R¹ = n-C₁₆H₃₃, o = 10, p = 1, Y = CO₂ and M = Na
^{d}corresponds to anionic surfactant (B) of the general formula (II) R²—O—(CH₂CH₂O)ₒ—(CH₂)ₚ—Y⁻ M⁺ with R² = n-C₁₈H₃₇, o = 10, p = 1, Y = CO₂ and M = Na
ⁱfrom ex. 2 a) [corresponds to the anionic surfactant (C) of the general formula (III) R³—O—(CH₂CHCH₃O)ₙ—(CH₂CH₂O)ₒ—(CH₂)ₚ—Y⁻ M⁺ with R³ = C₁₆H₃₃/C₁₈H₃₇, n = 7, o = 10, p = 1, Y = CO₂ and M = Na]

As can be seen in examples 1 to 11 from table 1, claimed surfactant mixtures at 80° C. and various salinities give low to ultralow interfacial tensions: 0.054 up to 0.0015 mN/in. Example 2 in table 1 indicates that ultralow interfacial tension values of 0.0096 mN/in can also be achieved with a mixture of anionic surfactant (A) and anionic surfactant (B). Examples 3 to 11 show clear robustness when the anionic surfactant (C) is added as a further component. Ultralow interfacial tensions are achieved with the same surfactant mixing ratios but different salinities (e.g. examples 5, 10 and 11), or ultralow interfacial tensions are achieved with the same salinity but different surfactant mixing ratio (e.g. examples 7, 9 and 11). On account of the average temperature of 80° C., by contrast with table 1, there is no need to add a cationic or betaine surfactant. All the formulations described in table 2 that are based on the alkyl ether carboxylates were soluble to give a clear solution at 80° C. and the respective salinity.

In order to demonstrate the broad applicability of the formulations claimed, various studies were conducted at 70° C.

TABLE 2
Interfacial tension after 30 min with surfactant mixture of anionic surfactant (A) of the
general formula (I) and anionic surfactant (B) of the general formula (II) and anionic
surfactant (C) of the general formula (III) on crude oil with API gravity 33 at 70° C.

| | | Active | | | Solubility of |
|---|---|---|---|---|---|
| | | substance of | | | the surfactant |
| | Surfactant formulation | the surfactant | Salt | IFT at | formulation |
| Example | in salt solution | solution | solution | 70° C. | at 70° C. |
| 1 | 78 mol % of C16C18-10EO-CH₂CO₂Na^{b} | 10 g/l | Salt content | 0.007 mN/m | Dissolves to |
| | (ratio of C16-10EO-CH₂CO₂Na^{c} | | 209 684 ppm | | give clear |
| | to C18-10EO-CH₂CO₂Na^{d} is 30:70 | | (deposit | | solution |
| | on a molar basis) to 22 mol % of | | water III) | | |
| | C16C18-7PO-10EO-CH₂CO₂Naⁱ | | | | |
| 2 | 78 mol % of C16C18-10EO-CH₂CO₂Na^{b} | 5 g/l | Salt content | 0.003 mN/m | Dissolves to |
| | (ratio of C16-10EO-CH₂CO₂Na^{c} | | 209 684 ppm | | give clear |
| | to C18-10EO-CH₂CO₂Na^{d} is 30:70 | | (deposit | | solution |
| | on a molar basis) to 22 mol % of | | water III) | | |
| | C16C18-7PO-10EO-CH₂CO₂Naⁱ | | | | |
| 3 | 78 mol % of C16C18-10EO-CH₂CO₂Na^{b} | 1 g/l | Salt content | 0.001 mN/m | Dissolves to |
| | (ratio of C16-10EO-CH₂CO₂Na^{c} | | 209 684 ppm | | give clear |
| | to C18-10EO-CH₂CO₂Na^{d} is 30:70 | | (deposit | | solution |
| | on a molar basis) to 22 mol % of | | water III) | | |
| | C16C18-7PO-10EO-CH₂CO₂Naⁱ | | | | |
| 4 | 78 mol % of C16C18-10EO-CH₂CO₂Na^{b} | 10 g/l | Salt content | 0.004 mN/m | Dissolves to |
| | (ratio of C16-10EO-CH₂CO₂Na^{c} | | 180 000 ppm | | give clear |
| | to C18-10EO-CH₂CO₂Na^{d} is 30:70 | | (deposit | | solution |
| | on a molar basis) to 22 mol % of | | water X) | | |
| | C16C18-7PO-10EO-CH₂CO₂Naⁱ | | | | |
| 5 | 86 mol % of C16C18-10EO-CH₂CO₂Na^{b} | 10 g/l | Salt content | 0.005 mN/m | Dissolves to |
| | (ratio of C16-10EO-CH₂CO₂Na^{c} | | 209 684 ppm | | give clear |
| | to C18-10EO-CH₂CO₂Na^{d} is 30:70 | | (deposit | | solution |
| | on a molar basis) to 14 mol % of | | water III) | | |
| | C16C18-7PO-10EO-CH₂CO₂Naⁱ | | | | |
| 6 | 88 mol % of C16C18-10EO-CH₂CO₂Na^{b} | 10 g/l | Salt content | 0.007 mN/m | Dissolves to |
| | (ratio of C16-10EO-CH₂CO₂Na^{c} | | 209 684 ppm | | give clear |
| | to C18-10EO-CH₂CO₂Na^{d} is 30:70 | | (deposit | | solution |
| | on a molar basis) to 12 mol % of | | water III) | | |
| | C16C18-7PO-15EO-CH₂CO₂Na^{j} | | | | |
| 7 | 81 mol % of C16C18-10EO-CH₂CO₂Na^{b} | 10 g/l | Salt content | 0.004 mN/m | Dissolves to |
| | (ratio of C16-10EO-CH₂CO₂Na^{c} | | 209 684 ppm | | give clear |
| | to C18-10EO-CH₂CO₂Na^{d} is 30:70 | | (deposit | | solution |
| | on a molar basis) to 19 mol % of | | water III) | | |
| | C16C18-7PO-15EO-CH₂CO₂Na^{j} | | | | |
| 8 | 64 mol % of C16C18-10EO-CH₂CO₂Na^{b} | 10 g/l | Salt content | 0.004 mN/m | Dissolves to |
| | (ratio of C16-10EO-CH₂CO₂Na^{c} | | 209 684 ppm | | give clear |
| | to C18-10EO-CH₂CO₂Na^{d} is 30:70 | | (deposit | | solution |
| | on a molar basis) to 36 mol % of | | water III) | | |
| | C16C18-7PO-15EO-CH₂CO₂Na^{j} | | | | |

^{b}from ex. 1a) [corresponds to the mixture of anionic surfactant A to the anionic surfactant B in a molar ratio of about 30:70, consisting of anionic surfactant (A) of the general formula (I) R¹—O—(CH₂CH₂O)ₒ—(CH₂)ₚ—Y⁻ M⁺ with R¹ = n-C₁₆H ₃₃, o = 10, p = 1, Y = CO₂ and M = Na and anionic surfactant (B) of the general formula (II) R²—O—(CH₂CH₂O)ₒ—(CH₂)ₚ—Y⁻ M⁺ with R² = n-C₁₈H₃₇, o = 10, p = 1, Y = CO₂ and M = Na]
^{c}corresponds to anionic surfactant (A) of the general formula (I) R¹—O—(CH₂CH₂O)ₒ—(CH₂)ₚ—Y⁻ M⁺ with R¹ = n-C₁₆H₃₃, o = 10, p = 1, Y = CO₂ and M = Na
^{d}corresponds to anionic surfactant (B) of the general formula (II) R²—O—(CH₂CH₂O)ₒ—(CH₂)ₚ—Y⁻ M⁺ with R² = n-C₁₈H₃₇, o = 10, p = 1, Y = CO₂ and M = Na
ⁱfrom ex. 2 a) [corresponds to the anionic surfactant (C) of the general formula (III) R³—O—(CH₂CHCH₃O)ₙ—(CH₂CH₂O)ₒ—(CH₂)ₚ—Y⁻ M⁺ with R³ = C₁₆H₃₃/C₁₈H₃₇, n = 7, o = 10, p = 1, Y = CO₂ and M = Na]
^{j}from ex. 2 b) [corresponds to the anionic surfactant (C) of the general formula (III) R³—O—(CH₂CHCH₃O)ₙ—(CH₂CH₂O)ₒ—(CH₂)ₚ—Y⁻ M⁺ with R³ = C₁₆H₃3/C₁₈H₃7, n = 7, o = 15, p = 1, Y = CO₂ and M = Na]

As can be seen in examples 1 to 8 of table 2, claimed surfactant mixtures comprising a mixture of anionic surfactant (A), anionic surfactant (B) and anionic surfactant (C) give ultralow interfacial tensions even at 70° C. and various salinities: 0.001 up to 0.007 mN/n. Examples 1 to 3 in table 2 show that the interfacial tensions are in the ultralow range even when the surfactant formulation has been diluted from 10 g/l to 1 g/l of active substance. Example 4 from table 2 and example 10 from table 1 both have ultralow interfacial tensions with the same surfactant formulations at the same salinity—but in one case at 70° C. and in one case at 80° C. Example 5 from table 2, by comparison with example 1 from table 2, shows that variation in the mixing ratio also still leads to ultralow interfacial tensions. Examples 6 to 8 show the robustness in the case of variation of the surfactant mixing ratio even when a different anionic surfactant (C) of the general formula (IV) is used.

The test that follows compared claimed surfactant formulations with different alkyl ethoxy carboxylates that have a noninventive level of ethoxylation or a branched alkyl radical.

TABLE 3
Solubilities of the surfactant mixture of anionic surfactant (A) of the general formula (I) and anionic surfactant
(B) of the general formula (II) compared to other alkyl ethoxy carboxylates based on branched alkyl radicals

| | | | | Solubility of |
|---|---|---|---|---|
| | | | | the surfactant |
| | Surfactant formulation | | | formulation at |
| Example | in salt solution | Salt solution | Temperature | temperature |
| 1 | 5 g/l of C16C18-10EO-CH₂CO₂Na^{b} | Salt content | 25° C. | Dissolves to |
| | (ratio of C16-10EO-CH₂CO₂Na^{c} | 135 000 ppm of | | give clear |
| | to C18-10EO-CH₂CO₂Na^{d} is 30:70 | NaCl and | | solution |
| | on a molar basis), 2.5 g/l of butyl diethylene glycol | 15 000 ppm of | | |
| | | CaCl₂ | | |
| 2 | 5 g/l of C16C18-10EO-CH₂CO₂Na^{b} | Salt content | 90° C. | Dissolves to |
| | (ratio of C16-10EO-CH₂CO₂Na^{c} | 135 000 ppm of | | give clear |
| | to C18-10EO-CH₂CO₂Na^{d} is 30:70 | NaCl and | | solution |
| | on a molar basis), 2.5 g/l of butyl diethylene glycol | 15 000 ppm of | | |
| | | CaCl₂ | | |
| V3 | 5 g/l of C16C18C20-Guerbet-18EO-CH₂CO₂Na, | Salt content | 25° C. | Dissolves to |
| | 2.5 g/l of butyl diethylene glycol | 135 000 ppm of | | give clear |
| | | NaCl and | | solution |
| | | 15 000 ppm of | | |
| | | CaCl₂ | | |
| V4 | 5 g/l of C16C18C20-Guerbet-18EO-CH₂CO₂Na, | Salt content | 90° C. | cloudy |
| | 2.5 g/l of butyl diethylene glycol | 135 000 ppm of | | |
| | | NaCl and | | |
| | | 15 000 ppm of | | |
| | | CaCl₂ | | |
| V5 | 5 g/l of C24C26C28-Guerbet-10EO-CH₂CO₂Na, | Salt content | 25° C. | cloudy |
| | 2.5 g/l of butyl diethylene glycol | 135 000 ppm of | | |
| | | NaCl and | | |
| | | 15 000 ppm of | | |
| | | CaCl₂ | | |
| V6 | 5 g/l of C24C26C28-Guerbet-10EO-CH₂CO₂Na, | Salt content | 90° C. | cloudy |
| | 2.5 g/l of butyl diethylene glycol | 135 000 ppm of | | |
| | | NaCl and | | |
| | | 15 000 ppm of | | |
| | | CaCl₂ | | |
| V7 | 5 g/l of C24C26C28-Guerbet-25EO-CH₂CO₂Na, | Salt content | 25° C. | Dissolves to |
| | 2.5 g/l of butyl diethylene glycol | 13 135 000 ppm | | give clear |
| | | of NaCl and | | solution |
| | | 15 000 ppm of | | |
| | | CaCl₂ | | |
| V8 | 5 g/l of C24C26C28-Guerbet-25EO-CH₂CO₂Na, | Salt content | 90° C. | cloudy |
| | 2.5 g/l of butyl diethylene glycol | 135 000 ppm of | | |
| | | NaCl and | | |
| | | 15 000 ppm of | | |
| | | CaCl₂ | | |

^{b}from ex. 1a) [corresponds to the mixture of anionic surfactant A to the anionic surfactant B in a molar ratio of about 30:70, consisting of anionic surfactant (A) of the general formula (I) R¹—O—(CH₂CH₂O)ₒ—(CH₂)ₚ—Y⁻ M⁺ with R¹ = n-C₁₆H ₃₃, o = 10, p = 1, Y = CO₂ and M = Na and anionic surfactant (B) of the general formula (II) R²—O—(CH₂CH₂O)ₒ—(CH₂)ₚ—Y⁻ M⁺ with R² = n-C₁₈H₃₇, o = 10, p = 1, Y = CO₂ and M = Na]
^{c}corresponds to anionic surfactant (A) of the general formula (I) R¹—O—(CH₂CH₂O)ₒ—(CH₂)ₚ—Y− M⁺ with R¹ = n-C₁₆H₃₃, o = 10, p = 1, Y = CO₂ and M = Na
^{d}corresponds to anionic surfactant (B) of the general formula (II) R²—O—(CH₂CH₂O)ₒ—(CH₂)ₚ—Y⁻ M⁺ with R² = n-C₁₈H₃₇, o = 10, p = 1, Y = CO₂ and M = Na

As can be inferred from examples 1 and 2 in table 3, the claimed surfactant formulations dissolve to give a clear solution in a saline water (salt content 150 000 ppm consisting of 135 000 ppm of NaCl and 15 000 ppm of CaCl₂), both at 25° C. and 90° C. It can be seen from comparative examples V4 to V8 that, surprisingly, noninventive surfactants predominantly still dissolve to give a clear solution at the lower temperature of 25° C., but this is no longer the case at 90° C. These noninventive surfactants are based on a branched alkyl radical of the Guerbet type (i.e. they have a branch in the 2 position and were prepared by dimerization of linear alcohols (see also WO2013/060670)). In addition, on comparison of example 2 with comparative examples V4 and V8, it can be seen that even a higher level of ethoxylation in the case of V4 and V8 was insufficient to achieve clear solubility at 90° C. Clear solubility is important in order to avoid blockage of the narrow-pore reservoir or to avoid excessive retention of the surfactant in the formation.

The next test was intended to explore the robustness of the surfactant formulation of the invention.

TABLE 4
Interfacial tension after 30 min with surfactant mixture of anionic surfactant (A) of the general
formula (I) and anionic surfactant (B) of the general formula (II) and anionic surfactant of the
general formula (IV) on crude oil with API gravity 33 at 70° C. at different concentrations

| | Surfactant formulation | | | | Solubility of |
|---|---|---|---|---|---|
| | with different amount | Active | | | the surfactant |
| | of active substance in | substance of | | IFT at | formulation |
| Example | salt solution | surfactant | Salt solution | 70° C. | at 70° C. |
| 1 | 86 mol % of C16C18-10EO-CH₂CO₂Na^{b} | 10 g/l | Salt content | 0.005 mN/m | Dissolves to give |
| | (ratio of C16-10EO-CH₂CO₂Na^{c} | | 210 000 ppm | | clear solution |
| | to C18-10EO-CH₂CO₂Na^{d} is 30:70 | | (deposit | | |
| | on a molar basis) to 14 mol % of | | water X) | | |
| | C16C18-7PO-10EO-CH₂CO₂Naⁱ | | | | |
| 2 | 86 mol % of C16C18-10EO-CH₂CO₂Na^{b} | 5 g/l | Salt content | 0.004 mN/m | Dissolves to give |
| | (ratio of C16-10EO-CH₂CO₂Na^{c} | | 210 000 ppm | | clear solution |
| | to C18-10EO-CH₂CO₂Na^{d} is 30:70 | | (deposit | | |
| | on a molar basis) to 14 mol % of | | water X) | | |
| | C16C18-7PO-10EO-CH₂CO₂Naⁱ | | | | |
| 3 | 86 mol % of C16C18-10EO-CH₂CO₂Na^{b} | 1 g/l | Salt content | 0.0008 mN/m | Dissolves to give |
| | (ratio of C16-10EO-CH₂CO₂Na^{c} | | 210 000 ppm | | clear solution |
| | to C18-10EO-CH₂CO₂Na^{d} is 30:70 | | (deposit | | |
| | on a molar basis) to 14 mol % of | | water X) | | |
| | C16C18-7PO-10EO-CH₂CO₂Naⁱ | | | | |
| 4 | 86 mol % of C16C18-10EO-CH₂CO₂Na^{b} | 0.5 g/l | Salt content | 0.0006 mN/m | Dissolves to give |
| | (ratio of C16-10EO-CH₂CO₂Na^{c} | | 210 000 ppm | | clear solution |
| | to C18-10EO-CH₂CO₂Na^{d} is 30:70 | | (deposit | | |
| | on a molar basis) to 14 mol % of | | water X) | | |
| | C16C18-7PO-10EO-CH₂CO₂Naⁱ | | | | |

^{b}from ex. 1a) [corresponds to the mixture of anionic surfactant A to the anionic surfactant B in a molar ratio of about 30:70, consisting of anionic surfactant (A) of the general formula (I) R¹—O—(CH₂CH₂O)ₒ—(CH₂)ₚ—Y⁻ M⁺ with R¹ = n-C₁₆H ₃₃, o = 10, p = 1, Y = CO₂ and M = Na and anionic surfactant (B) of the general formula (II) R²—O—(CH₂CH₂O)ₒ—(CH₂)ₚ—Y⁻ M⁺ with R² = n-C₁₈H₃₇, o = 10, p = 1, Y = CO₂ and M = Na]
^{c}corresponds to anionic surfactant (A) of the general formula (I) R¹—O—(CH₂CH₂O)ₒ—(CH₂)ₚ—Y⁻ M⁺ with R¹ = n-C₁₆H₃₃, o = 10, p = 1, Y = CO₂ and M = Na
^{d}corresponds to anionic surfactant (B) of the general formula (II) R²—O—(CH₂CH₂O)ₒ—(CH₂)ₚ—Y⁻ M⁺ with R² = n-C₁₈H₃₇, o = 10, p = 1, Y = CO₂ and M = Na
ⁱfrom ex. 2 a) [corresponds to the anionic surfactant (C) of the general formula (III) R³—O—(CH₂CHCH₃O)ₙ—(CH₂CH₂O)ₒ—(CH₂)ₚ—Y⁻ M⁺ with R³ = C₁₆H₃₃/C₁₈H₃₇, n = 7, o = 10, p = 1, Y = CO₂ and M = Na]

As can be inferred from examples 1 to 4 from table 4, most surprisingly, the interfacial tension between oil and water remains in the ultralow range from 0.0006 to 0.005 mN/m, even though the concentration of active substance in the surfactant formulation claimed is altered by a factor of 20 (from 500 to 10 000 ppm). This is a very great advantage in the flooding of the deposit, since the desired lowering of interfacial tension can also still be achieved at high dilution. For example, possible surfactant losses through adsorption are barely a factor or less of a factor.

TABLE 5
Appearance and properties of the surfactant concentrate

| | | Active | | Viscosity at |
|---|---|---|---|---|
| | Surfactant concentrate | content of | Appearance | 40° C. and |
| Example | from example 1a) | surfactant | at 40° C. | 10 s⁻¹ |
| 1 | C16C18-10EO-CH₂CO₂Na^{b} | 42% by wt. | homogeneous | 60 mPas |
| | (ratio of C16-10EO-CH₂CO₂Na^{c} | | and fluid | |
| | to C18-10EO-CH₂CO₂Na^{d} is 30:70 | | | |
| | on a molar basis) | | | |

^{b}from ex. 1a) [corresponds to the mixture of anionic surfactant A to the anionic surfactant B in a molar ratio of about 30:70, consisting of anionic surfactant (A) of the general formula (I) R¹—O—(CH₂CH₂O)ₒ—(CH₂)ₚ—Y⁻ M⁺ with R¹ = n-C₁₆H ₃₃, o = 10, p = 1, Y = CO₂ and M = Na and anionic surfactant (B) of the general formula (II) R²—O—(CH₂CH₂O)ₒ—(CH₂)ₚ—Y⁻ M⁺ with R² = n-C₁₈H₃₇, o = 10, p = 1, Y = CO₂ and M = Na]
^{c}corresponds to anionic surfactant (A) of the general formula (I) R¹—O—(CH₂CH₂O)o—(CH₂)ₚ—Y⁻ M⁺ with R¹ = n-C₁₆H₃₃, o = 10, p = 1, Y = CO₂ and M = Na
^{d}corresponds to anionic surfactant (B) of the general formula (II) R²—O—(CH₂CH₂O)ₒ—(CH₂)ₚ—Y⁻ M⁺ with R² = n-C₁₈H₃₇, o = 10, p = 1, Y = CO₂ and M = Na

As can be inferred from table 5, the claimed surfactant concentrate from example 1a) is very easy to handle at 40° C. It is a homogeneous, low-viscosity liquid which, in view of 60 mPas, can be pumped and dosed very easily (i.e. without high energy expenditure) (high dosage accuracy, no viscous lumps left behind).

Further surfactants of the invention were examined in order to support the breadth of the invention. For this purpose, the level of ethoxylation was varied.

TABLE 6
Interfacial tension after 30 min with surfactant mixture of anionic surfactant (A) of the general formula (I) and anionic
surfactant (B) of the general formula (II) on crude oil with API gravity 33 at 70° C. at various concentrations

| | Surfactant formulation | | | | Solubility of |
|---|---|---|---|---|---|
| | with different amount | Active | | | the surfactant |
| | of active substance in | substance of | | IFT at | formulation |
| Example | salt solution | surfactant | Salt solution | 70° C. | at 70° C. |
| 1 | 100 mol % of C16C18-8EO-CH₂CO₂Na^{k} | 10 g/l | Salt content | 0.001 mN/m | Dissolves to give |
| | (ratio of C16-8EO-CH₂CO₂Na^{c} | | 180 000 ppm | | clear solution |
| | to C18-8EO-CH₂CO₂Na^{d} is 30:70 | | (deposit | | |
| | on a molar basis) | | water X) | | |
| 2 | 100 mol % of C16C18-9EO-CH₂CO₂Na^{l} | 10 g/l | Salt content | 0.001 mN/m | Dissolves to give |
| | (ratio of C16-9EO-CH₂CO₂Na^{c} | | 180 000 ppm | | clear solution |
| | to C18-9EO-CH₂CO₂Na^{d} is 30:70 | | (deposit | | |
| | on a molar basis) | | water X) | | |

^{l}corresponds to the mixture of anionic surfactant A to the anionic surfactant B in a molar ratio of about 30:70, consisting of anionic surfactant (A) of the general formula (I) R¹—O—(CH₂CH₂O)ₒ—(CH₂)ₚ—Y⁻ M⁺ with R¹ = n-C₁₆H₃₃, o = 9, p = 1, Y = CO₂ and M = Na and anionic surfactant (B) of the general formula (II) R²—O—(CH₂CH₂O)ₒ—(CH₂)ₚ—Y⁻ M⁺ with R² = n-C₁₈H₃₇, o = 9, p = 1, Y = CO₂ and M = Na

As can be seen in table 6, even claimed surfactant formulations comprising surfactants with ethoxylation level of 8 or 9 give ultralow interfacial tensions of 0.001 and 0.008 mN/m respectively (examples 1 and 2).

TABLE 7
Interfacial tension after 30 min with surfactant mixture of anionic surfactant (A) of the
general formula (I) and anionic surfactant (B) of the general formula (II) and anionic
surfactant (C) of the general formula (III) on crude oil with API gravity 33 at 70° C.

| | | Active | | | Solubility of |
|---|---|---|---|---|---|
| | | substance of | | | the surfactant |
| | Surfactant formulation | the surfactant | | IFT at | formulation |
| Example | in salt solution | solution | Salt solution | 70° C. | at 70° C. |
| 1 | 100 mol % of C16C18-7EO-CH₂CO₂Na^{m} | 10 g/l | Salt content | 0.0085 mN/m | Slightly |
| | (ratio of C16-7EO-CH₂CO₂Na^{c} | | 130 000 ppm | | scattering |
| | to C18-7EO-CH₂CO₂Na^{d} is 30:70 | | (deposit water | | |
| | on a molar basis) | | III diluted | | |
| | | | with distilled | | |
| | | | water) | | |
| V2 | 100 mol % of C16-7EO-CH₂CO₂Naⁿ | 10 g/l | Salt content | 0.0160 mN/m | Slightly |
| | | | 130 000 ppm | | scattering |
| | | | (deposit water | | |
| | | | III diluted | | |
| | | | with distilled | | |
| | | | water) | | |

^{m}from ex. 1d) [corresponds to the mixture of anionic surfactant A to the anionic surfactant B in a molar ratio of about 30:70, consisting of anionic surfactant (A) of the general formula (I) R¹—O—(CH₂CH₂O)ₒ—(CH₂)ₚ—Y⁻ M⁺ with R¹ = n-C₁₆H ₃₃, o = 7, p = 1, Y = CO₂ and M = Na and anionic surfactant (B) of the general formula (II) R²—O—(CH₂CH₂O)ₒ—(CH₂)ₚ—Y⁻ M⁺ with R² = n-C₁₈H₃₇, o = 7, p = 1, Y = CO₂ and M = Na]
ⁿfrom ex. 1e) [corresponds to anionic surfactant (A) of the general formula (I) R¹—O—(CH₂CH₂O)ₒ—(CH₂)ₚ—Y⁻ M⁺ with R¹ = n-C₁₆H₃₃, o = 7, p = 1, Y = CO₂ and M = Na]

As can be seen in example 1 and comparative example V2 of table 7, claimed surfactant mixtures comprising a mixture of anionic surfactant (A) and the anionic surfactant (B) show almost half the low interfacial tension of the anionic surfactant (A) alone. Moreover, example 1 achieves ultralow interfacial tensions (0.0085 mN/m), whereas, in comparative example V2, interfacial tensions remain above 0.01 mN/m. The surfactants in example 1 and comparative example V2 have the same level of ethoxylation, and were prepared analogously to the other compounds. The results obtained show that a claimed mixture of surfactants (A) and (B) is more advantageous than the sole use of the corresponding surfactant (A). The surfactant C16-7 EO—CH₂CO₂Na from comparative example V2 is a surfactant that was disclosed in U.S. Pat. No. 4,457,373 A.

1. A method of producing mineral oil from an underground mineral oil deposit, in which an aqueous saline surfactant formulation comprising a surfactant mixture, for the purpose of lowering the interfacial tension between oil and water to <0.1 mN/m, is injected through at least one injection well into the mineral oil deposit and crude oil is withdrawn from the deposit through at least one production well, wherein
the mineral oil deposit is at a temperature of ≥25° C. and <130° C. and has formation water with a salinity of ≥50 000 ppm of dissolved salts,
and wherein the surfactant mixture comprises at least one anionic surfactant (A) of the general formula (I)
R¹—O—(CH₂CH₂O)ₒ—(CH₂)ₚ—Y⁻M⁺ (I)
and at least one anionic surfactant (B) of the general formula (II)
R²—O—(CH₂CH₂O)ₒ—(CH₂)ₚ—Y⁻M⁺ (II),
wherein there is a molar ratio of anionic surfactant (A) to anionic surfactant (B) in the surfactant mixture on injection of 90:10 to 10:90,
where
R¹ is a linear saturated or unsaturated aliphatic hydrocarbyl radical having 16 carbon atoms;
R² is a linear saturated or unsaturated aliphatic hydrocarbyl radical having two methylene groups more than R¹;
each Y is independently SO₃ or CO₂;
each M is independently Na, K, N(CH₂CH₂OH)₃H, N(CH₂CH(CH₃)OH)₃H, N(CH₃)(CH₂CH₂OH)₂H, N(CH₃)₂(CH₂CH₂OH)H, N(CH₃)₃(CH₂CH₂OH), N(CH₃)₃H, N(C₂H₅)₃H or NH₄;
each o is independently a number from 6 to 20;
where
p is the number 1 if Y is CO₂;
p is the number 0 if Y is SO₃;
where the surfactant mixture does not comprise any ionic surfactant of the general formula (III)
(R^{1a})ₖ—N⁺(R^{2a})₍₃₋ₖ₎R^{3a}(X⁻)ₗ (III)
where
each R^{1a} is independently a linear or branched, saturated or unsaturated, aliphatic hydrocarbyl radical having 8 to 22 carbon atoms, or is the R^{4a}—O—(CH₂C(R^{5a})HO)ₘₐ(CH₂C(CH₃)HO)ₙₐ—(CH₂CH₂O)ₒₐ—(CH₂CH₂)— or R^{4a}—O—(CH₂C(R^{5a})HO)ₘₐ—(CH₂C(CH₃)HO)ₙₐ—(CH₂CH₂O)ₒₐ—(CH₂C(CH₃)H)— radical;
each R^{2a} is CH₃;
R^{3a} is CH₃ or (CH₂CO₂)—;
each R^{4a} is independently a linear or branched, saturated or unsaturated, aliphatic hydrocarbyl radical having 8 to 36 carbon atoms or an aromatic or aromatic-aliphatic hydrocarbyl radical having 8 to 36 carbon atoms;
each R^{5a} is independently a linear or branched, saturated or unsaturated, aliphatic hydrocarbyl radical having 2 to 16 carbon atoms or an aromatic or aromatic-aliphatic hydrocarbyl radical having 6 to 10 carbon atoms;
X is Cl, Br, I or H₃CO—SO₃;
k is the number 1 or 2,
l is the number 0 or 1;
each ma is independently a number from 0 to 15;
each na is independently a number from 0 to 50;
each oa is independently a number from 1 to 60;
where
the sum total of na+oa is a number from 7 to 80;
l is the number 0 if R³ is (CH₂CO₂)— or is 1 if R³ is CH₃.

2. The method according to claim 1, wherein there is a molar ratio of anionic surfactant (A) to anionic surfactant (B) in the surfactant mixture on injection of 80:20 to 20:80.

3. The method according to claim 1, wherein R¹ is a linear saturated aliphatic primary hydrocarbyl radical having 16 carbon atoms.

4. The method according to claim 1, wherein R² is a linear saturated aliphatic primary hydrocarbyl radical having 18 carbon atoms.

5. The method according to claim 1, wherein o is a number from 6 to 15.

6. The method according to claim 1, wherein p is the number 1 and Y is CO₂.

7. The method according to claim 1, wherein the surfactant mixture comprises at least one anionic surfactant (C) of the general formula (IV)
R^{3b}—O—(CH₂CH(CH₃)O)_{nb}—(CH₂CH₂O)_{ob}—(CH₂)_{pb}—Y_{b}⁻M_{b}⁻ (IV)
where
R^{3b} is a linear or branched, saturated or unsaturated, aliphatic primary hydrocarbyl radical having 16 to 18 carbon atoms;
Y_{b} is SO₃ or CO₂;
M_{b} is Na, K, N(CH₂CH₂OH)₃H, N(CH₂CH(CH₃)OH)₃H, N(CH₃)(CH₂CH₂OH)₂H, N(CH₃)₂(CH₂CH₂OH)H, N(CH₃)₃(CH₂CH₂OH), N(CH₃)₃H, N(C₂H₅)₃H or NH₄;
nb is a number from 3 to 10;
ob is independently a number from 8 to 20;
pb is independently a number from 0 to 3;
where
pb is the number 1 if Y_{b} is CO₂;
pb is the number 0, 2 or 3 if Y_{b} is SO₃.

8. The method according to claim 1, wherein the mineral oil deposit has formation water having a salinity of ≥75 000 ppm of dissolved salts.

9. The method according to claim 1, wherein the mineral oil deposit has a temperature of ≥50° C.

10. The method according to claim 1, wherein mineral oil is produced from underground mineral oil deposits by means of Winsor type III microemulsion flooding.

11. The method according to claim 1, wherein the mineral oil deposit comprises carbonate rock.

12. A concentrate comprising, based in each case on the total amount of the concentrate,
20% by weight to 90% by weight of a surfactant mixture as specified in claim 1, where the molar ratio of anionic surfactant (A) to anionic surfactant (B) may be as desired,
5% to 40% by weight of water and
5% to 40% by weight of a cosolvent.

13. The concentrate according to claim 12, wherein the cosolvent is selected from the group of the aliphatic alcohols having 3 to 8 carbon atoms or from the group of the alkyl monoethylene glycols, the alkyl diethylene glycols or the alkyl triethylene glycols, where the alkyl radical is an aliphatic hydrocarbyl radical having 3 to 6 carbon atoms.

14. The concentrate according to claim 13, wherein the concentrate at 20° C. is free-flowing and at 50° C. has a viscosity of <10 000 mPas at 10 s⁻¹.

15. The use of a surfactant mixture as specified in claim 1 for production of mineral oil from underground mineral oil deposits.

16. The method according to claim 1, wherein there is a molar ratio of anionic surfactant (A) to anionic surfactant (B) in the surfactant mixture on injection of 30:70.

17. The method according to claim 1, wherein o is 10.

18. The method according to claim 1, wherein the mineral oil deposit has formation water having a salinity of 130 000 ppm of dissolved salts.

19. The method according to claim 1, wherein the mineral oil deposit has a temperature of ≥50° C. and <90° C.
